(19) United States
(12) Patent Application Publication
(10) Pub. No.: US 2020/0044933 A1
(43) Pub. Date: Feb. 6, 2020

(54) MANAGEMENT DEVICE AND MANAGEMENT METHOD

(71) Applicant: Mitsubishi Electric Corporation, Tokyo (JP)

(72) Inventor: Takumi SAEKI, Tokyo (JP)

(73) Assignee: Mitsubishi Electric Corporation, Tokyo (JP)

(21) Appl. No.: 16/467,070

(22) PCT Filed: Jan. 27, 2017
(86) PCT No.: PCT/JP2017/002972

§ 371 Date: Jun. 6, 2019

(51) Int. Cl. H04L 12/24

(52) U.S. Cl. CPC H04L 41/12; H04L 41/0866

(57) ABSTRACT

A management device that manages at least one device included in equipment includes: an information acquisition unit that acquires connection information indicating a connection point of a device associated with device-specific information of the device; and a management unit that provides information indicating the device associated with the connection information acquired by the information acquisition unit.

### FIELD

The present invention relates to a management device and a management method for managing connection conditions of devices constituting systems in factories and various kinds of social infrastructure equipment.

### BACKGROUND

In a system of equipment including devices, such as a factory and various kinds of social infrastructure equipment, monitoring and maintenance of the system are conducted. Patent Literature 1 teaches a technology of associating a device at a site with the position of the device in a layout of devices, which is managed by a data server, for checking a system. According to the technology described in Patent Literature 1, an operator reads an integrated tag code attached to the site and transmits the integrated tag code to the data server by operating a terminal for site checking and monitoring support. The data server transmits device layout data associated with the received integrated tag code to the site-checking-and-monitoring-support-terminal, and the site-checking-and-monitoring-support-terminal displays the device layout data. When a device to be checked is selected from the devices in the displayed device layout by the operator, a light emitting unit of a tag device associated with the selected device emits light.

### CITATION LIST

### Patent Literature

Patent Literature 1: Japanese Patent Application Laid-open No. 2008-139985

### SUMMARY

### Technical Problem

For monitoring and maintaining a system, a system configuration diagram including connections of devices is needed in some cases. In such a case, a management device that manages devices may generate a system configuration diagram on the basis of connection points of each of the devices, which are input by a user. In addition, information on connection points input by the user is verified by tests in advance. Thus, a worker at the site learns the system configuration, then transmits the system configuration to a user operating a management device, and the user then operates the management device.

A system configuration diagram generated by a management device is a virtual diagram, and does not necessarily match with a configuration reflecting actual connections. There may be various factors for which a system configuration diagram generated by a management device does not match with an actual configuration, including an error in checking the system configuration by a worker at the site, an error in transmission to a user operating the management device from a worker at the site, and failure in transmission to a user when the user made an erroneous input or the actual configuration has been changed.

As described above, in a case where a system configuration diagram in a management device and a configuration reflecting actual connections differ from each other, a device that is not intended by the user may be operated when the user operates a device on the basis of the system configuration diagram, which may cause malfunction.

Even if the technology described in Patent Literature 1 is applied to the system configuration diagram, the operator can only see which of actual devices a device on the system configuration diagram corresponds to, and the operator cannot check whether or not the connections of the devices are correct. In addition, because the device layout data are stored in advance in the data server in Patent Literature 1, the system configuration diagram will be set by a user in advance even if the technology described in Patent Literature 1 is applied to the system configuration diagram. Thus, even if the technology described in Patent Literature 1 is applied to the system configuration diagram, the problems caused in the case where the system configuration diagram that is made based on inputs from the user and the actual connections are different from each other as described above, cannot be solved.

The present invention has been made in view of the above, and an object thereof is to provide a management device and a management method capable of preventing or reducing malfunction when devices are operated on the basis of information held by the management device.

### Solution to Problem

To solve the aforementioned problems and achieve the object, a management device according to the present invention manages at least one device included in equipment. The management device includes an information acquisition unit and a management unit. The information acquisition unit acquires connection information indicating a connection point of a device associated with device-specific information of the device. The management unit provides information indicating the device associated with the connection information acquired by the information acquisition unit.

### Advantageous Effects of Invention

The management device according to the present invention produces an effect of providing a management device and a management method capable of preventing or reducing malfunction when devices are operated on the basis of information held by the management device.

### BRIEF DESCRIPTION OF DRAWINGS

FIG. 1 is a diagram illustrating an example of a management device according to a first embodiment.

FIG. 2 is a diagram illustrating a device managed by the management device according to the first embodiment.

FIG. 3 is a diagram illustrating a hardware configuration of the management device according to the first embodiment.

FIG. 4 is a diagram illustrating a hardware configuration of the management device according to the first embodiment.

FIG. 5 is a diagram illustrating an example of a hardware configuration of a portable terminal device according to the first embodiment.

FIG. 6 is a diagram illustrating an example of a hardware configuration of a device according to the first embodiment.

FIG. 7 is a diagram for explaining processes when the management device according to the first embodiment performs a management method according to the first embodiment.

FIG. 8 is a diagram illustrating an example of the management device 1, devices, and a subject device connected with networks in the first embodiment.

FIG. 9 is a diagram illustrating connections illustrated in FIG. 8 in a form of a tree structure in the first embodiment.

FIG. 10 illustrates configuration information according to the first embodiment in a form of a diagram.

FIG. 11 illustrates the configuration information according to the first embodiment in a form of a table.

FIG. 12 illustrates updated configuration information according to the first embodiment in a form of a diagram.

FIG. 13 illustrates the updated configuration information according to the first embodiment in a form of a table.

FIG. 14 illustrates updated configuration information according to the first embodiment in a form of a diagram.

FIG. 15 illustrates the updated configuration information according to the first embodiment in a form of a table.

FIG. 16 is a flowchart illustrating an example of processing performed by a portable terminal device according to the first embodiment.

FIG. 17 is a flowchart illustrating an example of procedures in a case where the management device according to the first embodiment has received an analysis result from a portable terminal device.

FIG. 18 is a diagram illustrating an example of a display screen displaying information indicating that device identification information is received and information prompting a user to input whether or not to perform search in the first embodiment.

FIG. 19 is a diagram illustrating an example of a screen prompting a user to input whether or not to update connection information in the first embodiment.

FIG. 20 is a diagram illustrating an example of a display screen of a configuration diagram in the first embodiment.

FIG. 21 is a diagram illustrating an example of a screen indicating that connection information is properly set in the first embodiment.

FIG. 22 is a diagram illustrating an example of a screen indicating that no device associated with device identification information is detected in the first embodiment.

FIG. 23 is a flowchart illustrating an example of operation of the management device in a case where a user checks the connection state of a device after connection points of devices of equipment are set in the first embodiment.

FIG. 24 is a diagram illustrating an example of a screen prompting a user to input whether or not to update connection information displayed in step S39 of FIG. 23 in the first embodiment.

FIG. 25 is a diagram illustrating an example of a screen displayed in a process of updating connection points in the first embodiment.

FIG. 26 is a diagram illustrating an example of a system configuration diagram display part in a state before update in the first embodiment.

FIG. 27 is a diagram illustrating an example of a screen displaying that a device matching with connection information is detected in the first embodiment.

FIG. 28 is a diagram illustrating an example of a screen indicating that update of a device is completed in the first embodiment.

### DESCRIPTION OF EMBODIMENTS

A management device and a management method according to an embodiment of the present invention will be described in detail below with reference to the drawings.

Note that the present invention is not limited to the embodiment.

### First Embodiment

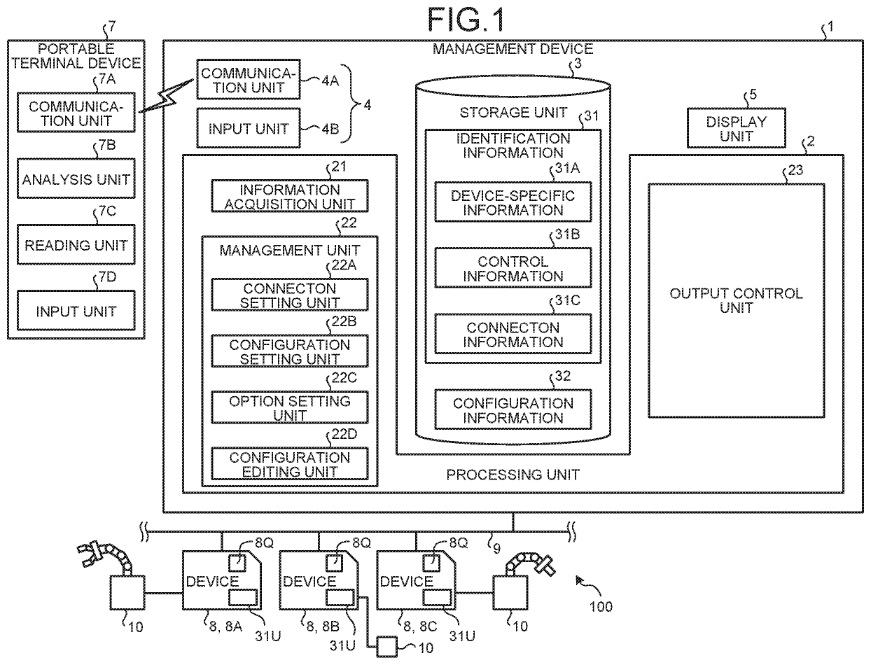

FIG. 1 is a diagram illustrating an example of a management device 1 according to a first embodiment. The management device 1 is a device that manages devices 8 included in equipment 100. Examples of the equipment 100 include, but are not limited to, production equipment in factories and various kinds of infrastructure equipment. In the first embodiment, the equipment 100 is a system for factory automation (FA), that is, automation of production processes in a factory. The equipment 100 includes three devices 8A, 8B, and 8C in the first embodiment; the equipment 100, however, it is sufficient that the equipment 100 includes at least one device 8.

The management device 1 manages a plurality of devices 8, which are three devices 8 in the first embodiment; the number of devices managed by the management device 1 is not limited. In the equipment 100, the devices 8 to be managed by the management device 1 may be changed.

The equipment 100 includes the management device 1, the devices 8, a network 9 to which the management device 1 and the devices 8 are connected, and machines 10 controlled by the devices 8. The machines 10 are controlled by the devices 8. The machines 10 are machine tools, robots, assembling equipment, and conveyors used in production in production equipment in a factory, but are not limited thereto. The machines 10 may be sorters, outdoor equipment, indoor equipment, pumps, valves, and fans.

The management device 1 provides the devices 8 with programs for causing the devices 8 to operate devices 8, to make the devices 8 operate in accordance with the programs and manage the states of connection of the devices 8 to the network 9. Examples of the programs provided to the devices 8 include, but are not limited to, programs for controlling the machines 10 by the devices 8.

The management device 1 includes a processing unit 2, a storage unit 3, a reception unit 4, and a display unit 5. The management device 1 is a general-purpose computer such as a personal computer in the first embodiment, but is not limited to a general-purpose computer. The processing unit 2 includes an information acquisition unit 21, a management unit 22, and an output control unit 23.

The information acquisition unit 21 acquires device-specific information 31A of each of the devices 8 included in the equipment 100 to identify the devices 8. More specifically, in the equipment 100, the information acquisition unit 21 identifies the devices 8 by acquiring connection information 31C indicating devices with which each of the devices 8 of the equipment 100 is connected on the basis of the device-specific information 31A of each of the devices 8. In other words, the information acquisition unit 21 acquires connection information 31C of a device 8 associated with device-specific information 31A to identify the device 8. A connection point of a device 8 includes devices with which the device 8 is connected directly via the network 9 of the equipment 100, and also include devices with which the device 8 is connected directly or indirectly on a path between the device 8 and the management device 1. Device-specific information 31A used by the information acquisition unit 21 to identify a device 8 may be the device-specific information 31A acquired from the device 8 installed in the equipment 100 or may be device-specific information 31A of the device 8 specified by a user.

To acquire connection information 31C, the information acquisition unit 21 search for a device 8 to be identified via a communication unit 4A. The search performed by the information acquisition unit 21 is a process of acquiring information on devices on the path to the device 8 being searched for. An example of such a process uses a ping command, but the process is not limited thereto.

The device-specific information 31A is information enabling a device 8 and another device 8 to be distinguished from each other. Examples of the device-specific information 31A include, but are not limited to, the names, serial numbers, and model numbers of the devices 8. The connection information 31C is information indicating at least one of the location at which a device 8 is connected and the path from the management device 1 to the device 8 in the network 9 of the equipment 100. Examples of the connection information 31C include, but are not limited to, information on the address of a device 8 in the network 9 and the path from the management device 1 to the device 8 in the network 9. Examples of the aforementioned information on the path include, but are not limited to, information on devices on the path from the management device 1 to the device 8 in the network 9.

The management unit 22 includes a connection setting unit 22A, a configuration setting unit 22B, an option setting unit 22C, and a configuration editing unit 22D. The management unit 22 performs a process of managing identification information 31 and configuration information 32, which are information stored in the storage unit 3. The management unit 22 associates the connection information 31C and the device-specific information 31A acquired by the information acquisition unit 21 with each other, and also associates the device-specific information 31A with the configuration of the device 8 in the configuration information 32 indicating the configuration of the equipment 100. Alternatively, the management unit 22 associates the connection information 31C with the device-specific information 31A and also associates the device-specific information 31A associated with the connection information 31C with the configuration of the device 8 in the configuration information 32.

The configuration information 32 includes the device-specific information 31A of each of the devices 8 constituting the equipment 100. The configuration information 32 is information on the basis of which a configuration diagram illustrating the configuration of the equipment 100 is displayed on the display unit 5. The configuration diagram is a virtual drawing illustrating connection states of the network 9 with the devices 8 and the management device 1 included in the equipment 100. The configuration information 32 may be information for displaying at least the configuration diagram on the display unit 5, and may be information for displaying information other than the configuration diagram on the display unit.

It is sufficient that the configuration information 32 includes at least the device-specific information 31A. The configuration information 32 may include, in addition to the device-specific information 31A, the connection information 31C associated with the device-specific information 31A by the management unit 22. Alternatively, the configuration information 32 may include the device-specific information 31A and further include information for associating the connection information 31C included in the identification information 31 with the device-specific information 31A.

The connection setting unit 22A of the management unit 22 acquires the connection information 31C, which is information indicating the connection paths of the devices 8 in the network 9 on the basis of inputs received by the reception unit 4, and stores the connection information 31C in the storage unit 3. The connection setting unit 22A stores the device-specific information 31A and the generated connection information 31C in association with each other in the storage unit 3. In addition, when it is determined, on the basis of the result of the search process performed by the information acquisition unit 21, that the connection point of the device 8 is not properly set, the connection setting unit 22A updates the connection point of the device 8 on the basis of the result of the search process. The update of the connection point of the device 8 is performed when an input indicating to update the connection point is received via an input unit 4B. To update the connection point of the device 8, the connection setting unit 22A replaces the connection information 31C associated with the device-specific information 31A with new connection information 31C.

The configuration setting unit 22B associates the device-specific information 31A with the configuration of the device 8 in the configuration information 32. The configuration setting unit 22B assigns the device-specific information 31A associated with the connection information 31C to the configuration information 32.

The management unit 22 informs the user of the device 8 identified by the information acquisition unit 21, more specifically, information indicating the identified device 8. The information indicating the identified device 8 is information for distinguishing the identified device 8 from the other devices 8 included in the equipment 100 illustrated in FIG. 1. The provision of information is performed by the configuration setting unit 22B of the management unit 22. More specifically, the configuration setting unit 22B informs the user of the device 8 that is identified using the connection information 31C acquired by the information acquisition unit 21 and whose connection information 31C and device-specific information 31A are associated with each other by the connection setting unit 22A. In a case where the device 8 identified by the information acquisition unit 21 is to be displayed in the configuration diagram, the option setting unit 22C informs the user of the device 8 identified by the information acquisition unit 21 by displaying the device 8 in the configuration diagram in a mode different from others, such as in a mode different from the other devices displayed in the configuration diagram. The device 8 identified by the information acquisition unit 21 is a device 8 associated with the connection information 31C acquired by the information acquisition unit 21. Thus, the information indicating the identified device 8 is information indicating the device 8 associated with the connection information 31C acquired by the information acquisition unit 21.

Examples of display in a mode different from others include display of the subject device 8 in an illuminated state, display of the subject device 8 in a flashing state, display of the subject device 8 with a color different from those of the other devices 8, and display of the subject device 8 with heavy lines, in the configuration diagram. Display in a mode different from others is not limited to the examples. The management unit 22 controls the display in this manner. The configuration editing unit 22D edits display data for displaying the configuration diagram on the screen of the display unit 5.

The output control unit 23 displays an image on the display unit 5 in accordance with an instruction from the management unit 22. More specifically, the output control unit 23 displays the device 8 identified by the information acquisition unit 21 of the management unit 22 on the display unit 5. The output control unit 23 generates the image data to be displayed on the display unit 5 and also outputs the generated image data to the display unit 5 to display the image data. More specifically, the output control unit 23 displays, in the configuration diagram of the equipment 100, the device 8 identified by the information acquisition unit 21 in a mode different from the other components of the equipment 100 in accordance with an instruction from the option setting unit 22C on the display unit 5. The output control unit 23 edits the display data for displaying the configuration diagram on the screen.

As described above, the management unit 22 informs the user of the device 8 identified by the information acquisition unit 21 by displaying the identified device 8 on the display unit 5 via the output control unit 23. In addition, the management unit 22 informs the user of the device 8 identified by the information acquisition unit 21 by displaying the identified device 8 in a mode different from the other components on the display unit 5 via the output control unit 23. In the first embodiment, the management unit 22 may inform the user of the device 8 identified by the information acquisition unit 21 by using audio, by printing the information on a paper, or the like, instead of displaying the device 8 on the display unit 5. In this case, the output control unit 23 outputs the information of the device 8 identified by the information acquisition unit 21 in accordance with an instruction from the management unit 22.

As described above, the provision of information in the first embodiment includes, but is not limited to, display on the display unit 5, the provision using audio, and printing on a recording medium. In a case of informing the user of the information indicating the identified device 8 by display on the display unit 5, an icon denoting the identified device 8 corresponds to the information indicating the identified device 8, for example. In a case of informing the user of the information indicating the identified device 8 by audio, audio denoting the identified device 8 corresponds to the information indicating the identified device 8, for example. In a case of informing the user of the information indicating the identified device 8 by printing on a recording medium, an image, a text, or numbers denoting the identified device 8 correspond to the information indicating the identified device 8, for example.

The storage unit 3 stores the identification information 31 and the configuration information 32. The identification information 31 includes the device-specific information 31A, control information 31B, and the connection information 31C. The control information 31B is information on processes that a device 8 can perform. The configuration information 32 is information including the devices 8 included in the equipment 100 and the device-specific information 31A of each of the devices 8 associated with the corresponding device 8. In a case where the configuration information 32 is a configuration diagram of the equipment 100, each piece of information corresponding to each of images of the devices 8A, 8B, and 8C included in the configuration diagram is associated with the device-specific information 31A of the corresponding one of the devices 8A, 8B, and 8C. The data format of the identification information 31 is not particularly limited, but one entry is provided for each one device 8 and a format including the device-specific information 31A, the control information 31B, and the connection information 31C in one entry is used.

The reception unit 4 receives an input to the management device 1. Examples of the input to the management device 1 include the device identification information 31U held by a device 8, information on the state of a machine 10 controlled by a device 8, and information on the state of a device 8. The device identification information 31U includes the device-specific information 31A and the control information 31B, but only needs to include at least the device-specific information 31A.

The reception unit 4 includes a communication unit 4A and an input unit 4B. The communication unit 4A communicates with a portable terminal device 7, and communicates with a computer other than the devices 8 connected to the network 9 and the management device 1. The communication unit 4A transmits and receives information to and from the portable terminal device 7 via radio communication, but may alternatively transmits and receive information to and from the portable terminal device 7 via cable communication. The input unit 4B receives an input from the user of the management device 1. As will be described later, the reception unit 4 receives the device identification information 31U acquired from a device 8 acquired by the portable terminal device 7. Thus, the reception unit 4 functions as an acquisition unit that acquires the identification information of a device 8, that is, the device identification information 31U. The input unit 4B is a touch panel, a keyboard, a pointing device, or another input device.

The portable terminal device 7 is a terminal device that is portable, and typified by a tablet terminal and a smartphone. A worker who installs and checks the devices 8 carries a portable terminal device 7 when the worker goes to the location where a device 8 is installed. Alternatively, the portable terminal device 7 may be set at the location, and the worker may take the portable terminal device 7 from the set position when using the portable terminal device 7.

The portable terminal device 7 includes a communication unit 7A, an analysis unit 7B, a reading unit 7C, and an input unit 7D. The portable terminal device 7 acquires and analyzes the device identification information 31U of a device 8, and transmits the analysis result to the management device 1. More specifically, the reading unit 7C reads an identification information transfer part 8Q of the device 8. The reading unit 7C is an imaging device including an image sensor such as a charge coupled device (CCD) or a complementary metal oxide semiconductor (CMOS). The analysis unit 7B analyzes the identification information transfer part 8Q read by the reading unit 7C, and restores the device identification information 31U from the identification information transfer part 8Q. When both of the device-specific information 31A and the control information 31B are included in the device identification information 31U, the analysis unit 7B may restore at least the device-specific information 31A of the device 8.

The communication unit 7A transmits the device identification information 31U that is the analysis result of the analysis unit 7B, and at least the device-specific information 31A in the first embodiment, to the management device 1. The device-specific information 31A transmitted from the portable terminal device 7 is received by the communication unit 4A of the management device 1. The communication unit 4A stores the received device-specific information 31A in the storage unit 3. The input unit 7D receives an input from the user.

In the first embodiment, the devices 8 are various devices including programmable logic controllers (PLCs). In the first embodiment, the devices 8 are assumed to be programmable logic controllers. Programmable logic controllers are specified in JIS B 3502:2011 of the Japanese Industrial Standards (JIS). Machines 10 to be controlled by the devices 8 are connected with the devices 8. The devices 8 are installed at sites including factories, that is, at locations where the devices 8 operate.

The devices 8 receive programs for controlling the machines 10 from the management device 1 via the network 9. The devices 8 then operate according to the received programs to control the machines 10. The devices 8 are not limited to programmable logic controllers as long as the devices 8 receive programs from the management device 1 to operate.

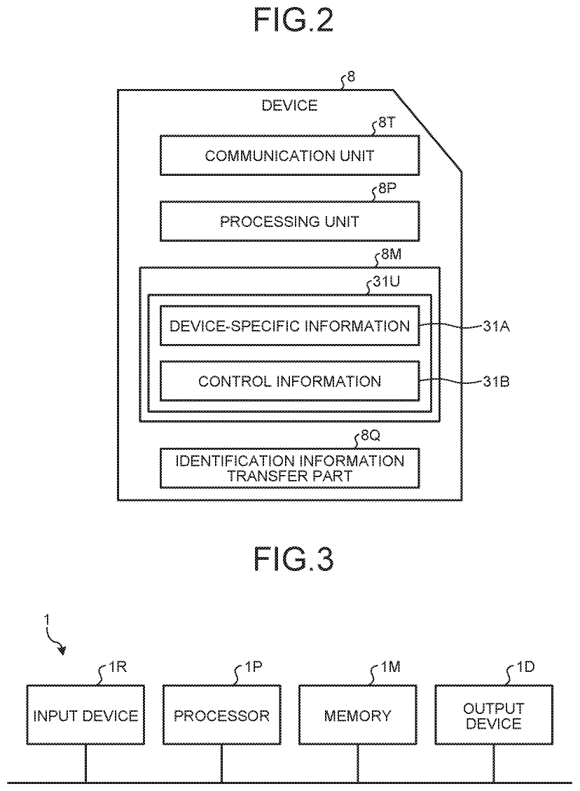

FIG. 2 is a diagram illustrating a device 8 managed by the management device 1 according to the first embodiment. The device 8 includes a communication unit 8T, a processing unit 8P, and a storage unit 8M. The communication unit 8T communicates with the management device 1 illustrated in FIG. 1 via the network 9 illustrated in FIG. 1, and communicates with the machine 10 (see FIG. 1) connected with the device 8. The processing unit 8P controls the machine 10 by executing a program transmitted from the management device 1 via the network 9. The storage unit 8M stores the device identification information 31U including the device-specific information 31A and the control information 31B.

The device-specific information 31A stored in the storage unit 8M is information assigned to each of individual devices 8. In the first embodiment, the device-specific information 31A and the control information 31B are embedded in the identification information transfer part 8Q. At least the device-specific information 31A among the device-specific information 31A and the control information 31B of the device 8 is embedded in the identification information transfer part 8Q.

The identification information transfer part 8Q is an identification information transfer part two-dimensional code, image, character string, numeric string, or combination thereof, that is attached to outside of the device 8. The identification information transfer part 8Q is pasted on a housing of the device 8 or directly written on the housing of the device 8. The devices 8 included in the equipment 100 have similar configurations, but the device-specific information 31A and the control information 31B associated with each of the devices 8 is different from those of different devices 8.

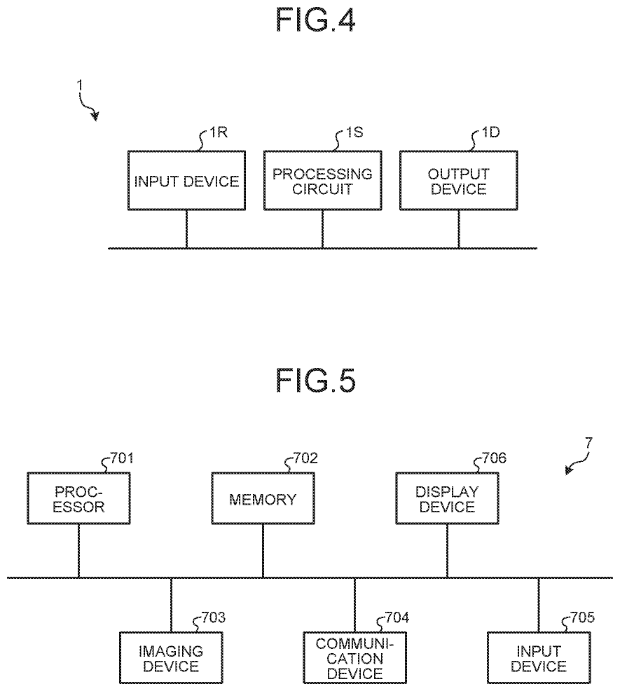

FIGS. 3 and 4 are diagrams illustrating hardware configurations of the management device 1 according to the first embodiment. In a case where the functions of the management device 1 illustrated in FIG. 1 are implemented by software, the management device 1 includes an input device 1R, a processor 1P, a memory 1M, and an output device 1D, as illustrated in FIG. 3. The functions of the processing unit 2 included in the management device 1, that is, more specifically, the functions of the information acquisition unit 21, the management unit 22, and the output control unit 23 are implemented by the processor 1P. The processor 1P may also be referred to as a central processing unit (CPU), a processing device, a computing device, a microprocessor, a microcomputer, or a digital signal processor (DSP).

In this case, the functions of the information acquisition unit 21, the management unit 22, and the output control unit 23 illustrated in FIG. 1 are implemented by software, firmware, or a combination of software and firmware. The software and firmware are described in the form of programs and stored in the memory 1M. The processor 1P implements the functions of the information acquisition unit 21, the management unit 22, and the output control unit 23 by reading and executing the programs stored in the memory 1M. In other words, these programs cause a computer to execute procedures performed by the information acquisition unit 21, the management unit 22, and the output control unit 23 and a management method according to the first embodiment. The memory 1M is also used as a temporary storage device when the processor 1P performs various processes.

The memory 1M implements the functions of the storage unit 3 of the management device 1 illustrated in FIG. 1. The memory 1M may be a volatile or nonvolatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disc, a mini disc, or a digital versatile disc (DVD).

The input device 1R implements the functions of the reception unit 4 of the management device 1 illustrated in FIG. 1. The input device 1R is a receiver, a touch panel, a keyboard, or a pointing device. The output device 1D implements the functions of the display unit 5 of the management device 1 illustrated in FIG. 1. The output device 1D is a liquid crystal display panel, an organic electroluminescence (EL) panel, a cathode ray tube (CRT), a printer, or a speaker.

The functions of the information acquisition unit 21, the management unit 22, and the output control unit 23 included in the management device 1 illustrated in FIG. 1 may be implemented by a processing circuit 1S illustrated in FIG. 4. The processing circuit 1S is dedicated hardware for implementing the functions of the information acquisition unit 21, the management unit 22, and the output control unit 23. The processing circuit 1S may be a single circuit, a composite circuit, a programmed processor, a parallel-programmed processor, an application specific integrated circuit (ASIC), a field programmable gate array (FPGA), or a combination thereof. The functions of the information acquisition unit 21, the management unit 22, and the output control unit 23 may be implemented by different processing circuits 1S, or may collectively be implemented by a single processing circuit 1S.

Some of the functions of the information acquisition unit 21, the management unit 22, and the output control unit 23 may be implemented by dedicated hardware, and others may be implemented by software or firmware. As described above, the management device 1 is capable of implementing the functions of the information acquisition unit 21, the management unit 22, and the output control unit 23 by hardware, software, firmware, or combination thereof.

FIG. 5 is a diagram illustrating an example of a hardware configuration of a portable terminal device 7 according to the first embodiment. As illustrated in FIG. 5, the portable terminal device 7 includes a processor 701, a memory 702, an imaging device 703, a communication device 704, an input device 705, and a display device 706. The processor 701 is at least one of a CPU and a microprocessor. The memory 702 is at least one of a hard disk drive, an SSD, and a RAM. The imaging device 703 is a camera. The communication device 704 is a receiver and transmitter. The input device 705 is at least one of a keyboard, a mouse, and a touch panel. The display device 706 is a liquid crystal panel or an organic EL panel.

The communication unit 7A illustrated in FIG. 1 is implemented by the communication device 704, the reading unit 7C illustrated in FIG. 1 is implemented by the imaging device 703, and the input unit 7D illustrated in FIG. 1 is implemented by the input device 705. The analysis unit 7B is implemented by the processor 701 by executing a program, stored in the memory 702, for performing processing of the analysis unit 7B. The memory 702 is also used as a temporary storage unit when the processor 701 performs the processing.

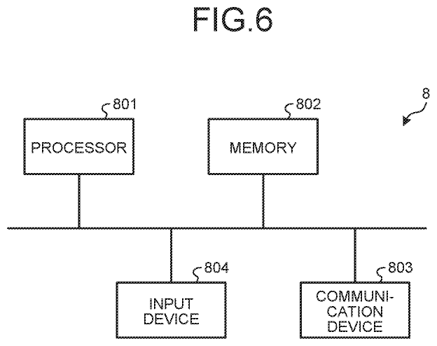

FIG. 6 is a diagram illustrating an example of a hardware configuration of a device 8 according to the first embodiment. As illustrated in FIG. 6, the device 8 includes a processor 801, a memory 802, a communication device 803, and an input device 804. The processor 801 is at least one of a CPU and a microprocessor. The memory 802 is at least one of a hard disk drive, an SSD, and a RAM. The communication device 803 is a receiver and transmitter. The input device 804 includes at least one of a keyboard, a mouse, and a touch panel. The processing unit 8P illustrated in FIG. 2 is implemented by the processor 801, the storage unit 8M is implemented by the memory 802, and the communication unit 8T is implemented by the communication device 803. The device 8 need not necessarily include the input device 804.

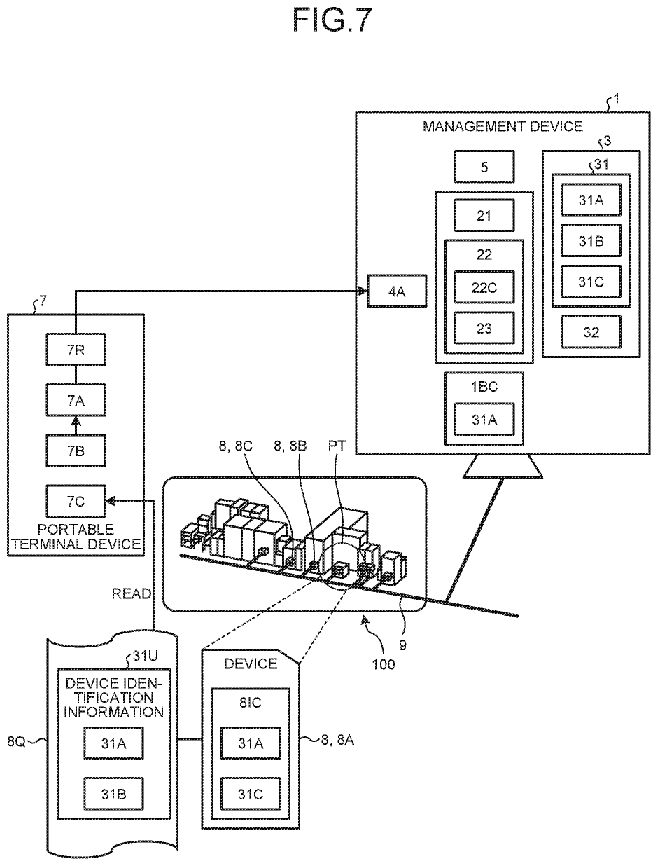

FIG. 7 is a diagram for explaining processes when the management device 1 according to the first embodiment performs the management method according to the first embodiment. FIG. 7 illustrates devices 8 of the equipment 100, which are installed at a site. The management device 1 manages the connection point of a device 8 in the network 9 of the equipment 100 by associating the device-specific information 31A and the connection information 31C of the device 8 with each other, and further associating the device-specific information 31A with the device 8 in the configuration information 32. In a case where the connection point of the device 8 in the network 9 has been changed, the management device 1 performs the management method according to the first embodiment to update the association between the device-specific information 31A and the connection information 31C of the device 8 managed by the management device 1. In addition, the management device 1 performs the management method according to the first embodiment to associate the device-specific information 31A with the connection information 31C of a device 8 that is newly connected with the network 9, and associates the device-specific information 31A with the device 8 in the configuration information 32.

A user checks in some cases whether or not the connection point of the devices 8 in the network 9, which is managed by the management device 1, is correct before the equipment 100 operates. A user in some cases wants to add a device 8 that is newly added to the network 9 to the configuration information 32. In such cases, the user goes to the site, and causes the reading unit 7C of a portable terminal device 7 to read the identification information transfer part 8Q of a device 8 for which the connection point is to be checked.

In this example, a device 8 that the user wants to check or add will be referred to as a device 8A. The device 8A has the identification information transfer part 8Q pasted thereon. In this state, the user operates the portable terminal device 7 to cause the portable terminal device 7 to read the identification information transfer part 8Q. The device 8 that the user wants to check or add is denoted by PT in FIG. 7.

The portable terminal device 7 that has read the identification information transfer part 8Q analyzes the identification information transfer part 8Q by the analysis unit 7B. The analysis result 7R is transmitted from the communication unit 7A of the portable terminal device 7 to the communication unit 4A of the management device 1. Upon receiving the analysis result 7R from the portable terminal device 7, the management device 1 searches the identification information 31 stored in the storage unit 3 and determines whether or not the connection information 31C associated with the device-specific information 31A of the device 8 is present. If the connection information 31C associated with the device-specific information 31A of the device 8 is not present, the management device 1 performs a search process. The search process is a process performed by the management device 1 to obtain the connection information 31C of the device 8A on the basis of the device-specific information 31A included in the analysis result 7R.

The management device 1 searches a range that is accessible from the management device 1 on the basis of the device-specific information 31A of the device 8. The accessible range depends on the types of network such as universal serial bus (USB) and Ethernet (registered trademark), and the maximum distance, that is, the number of networks via which the search is performed. Because the management device 1 searches paths in the accessible range, the management device 1 can determine, within a certain period, whether or not a signal for the search has reached the subject device 8. In the search, when receiving a response from the subject device 8 after transmitting the signal for the search, the management device 1 can find out the presence of the subject device 8 and the location where the subject device 8 is connected.

The time taken for the management device 1 from starting the search for the subject device 8 to receiving the response from the subject device 8 is proportional to the distance from the management device 1 to the subject device 8. Thus, the management device 1 can obtain the distance from the management device 1 to the subject device 8 on the basis of the time taken from starting the search to receiving the response from the subject device 8. The management device 1 can obtain the path from the management device 1 to the subject device 8 and the location where the subject device 8 is connected in the network 9 on the basis of the distance from the management device 1 to the subject device 8 and the configuration of the network 9 connected with the management device 1.

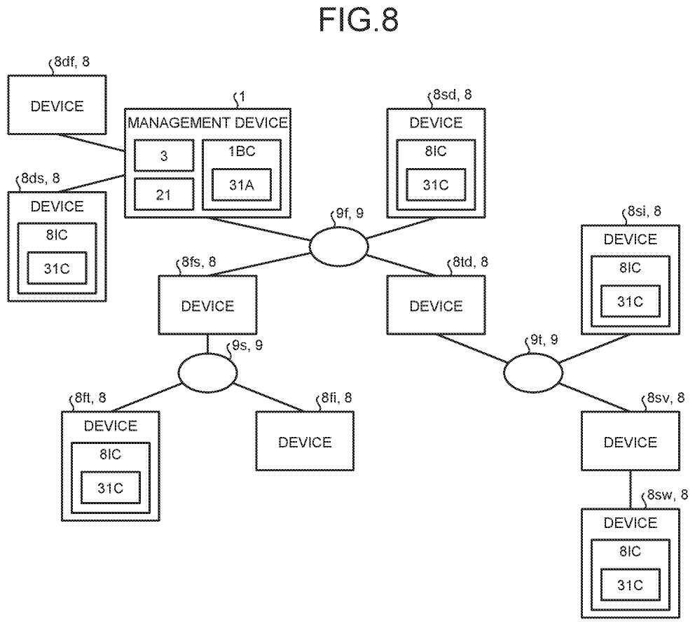

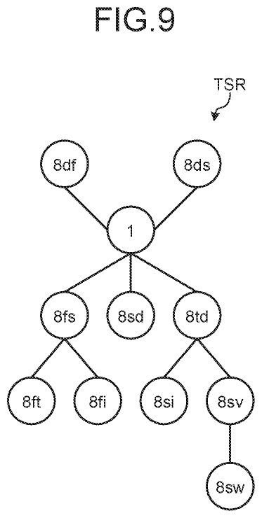

FIG. 8 is a diagram illustrating an example of the management device 1, devices 8fs, 8sd, 8td, 8ft, 8fi, 8si, 8sv, 8SW, 8df, and 8ds and the subject device 8TG connected with networks 9f, 9s, and 9t in the first embodiment. FIG. 9 is a diagram illustrating the connections illustrated in FIG. 8 in a form of a tree structure TSR in the first embodiment. In the example illustrated in FIG. 8, the management device 1 is connected with the network 9f. The devices 8sd, 8fs, and 8td are connected with the network 9f. The device 8fs is connected with the network 9s. The devices 8ft and 8fi are connected with the network 9s. The network 9t is connected with the device 8td. The devices 8si and 8sv are connected with the network 9t. The device 8sw is connected with the device 8sv. The devices 8df and 8ds are directly connected with the management device 1. In the description below, the devices 8fs, 8sd, 8td, 8ft, 8fi, 8si, 8sv, 8SW, 8df, and 8ds will be referred to as devices 8 when the devices are not distinguished from each other, and the networks 9f, 9s, and 9t will be referred to as networks 9 when the networks are not distinguished from each other.

The management device 1 has setting information of devices connected with the management device 1. The setting information includes the types of the connected devices, the modes of connection of the connected devices, and the addresses of the connected devices. Examples of the types of the connected devices include the types of networks such as universal serial bus (USB) and Ethernet (registered trademark). Examples of the mode of connection of the connected devices include direct connection with the management device 1 and connection with the management device 1 via a network 9. Examples of the addresses of the connected devices include the addresses of the devices 8 that are directly connected with the management device 1 and the addresses of the devices 8 that are connected with the management device 1 via the network 9f. Examples of the addresses include area codes and Internet protocols (IPs).

The devices 8 connected with the management device 1 are classified into groups provided below. One or more devices 8 belong to each group.

Group 1: devices 8df and 8ds directly connected with the management device 1

Group 2: devices 8fs, 8sd, and 8td connected with the management device 1 via the network 9f

Group 3: devices 8ft and 8fi connected with the management device 1 via the network 9f, the device 8fs, and the network 9s

Group 4: devices 8si and 8sv connected with the management device 1 via the network 9f, the device 8td, and the network 9t

Group 5: device 8sw connected with the management device 1 via the network 9f, the device 8td, the network 9t, and the device 8sv

The devices 8df and 8ds directly connected with the management device 1 belong to the group 1. The devices 8fs, 8sd, and 8td connected with the management device 1 via one network 9f belong to the group 2. The devices 8ft and 8fi connected with the management device 1 via two networks 9f and 9t and the device 8fs belong to the group 3. The devices 8si and 8sv connected with the management device 1 via two networks 9f and 9s and the device 8td belong to the group 4. The device 8sw connected with the management device 1 via two networks 9f and 9t and two devices 8td and 8sv belongs to the group 5.

In the group 1, the number of at least either of networks 9 and devices 8 present between the management device 1 and the devices in the group 1 (hereinafter referred to as the number of networks 9, etc. as appropriate) is the smallest. More specifically, in the group 1, because no networks 9 or devices 8 are present between the management device 1 and the devices in the group 1, the number of networks 9, etc. is 0. In the group 2, the number of networks 9, etc. present between the management device 1 and the devices in the group 2 is the second smallest after the group 1. In the groups 3 and 4, the number of networks 9, etc. present between the management device 1 and the devices in the groups 3 and 4 is the third smallest after the group 2. In the group 5, the number of networks 9, etc. present between the management device 1 and the device in the group 5 is the largest.

In the first embodiment, the management device 1, or more specifically, the information acquisition unit 21 searches the devices 8 in the order based on the number of networks 9, etc. present between the management device 1 and the subject device 8 that is searched for. More specifically, the management device 1 searches the devices 8 in ascending order of the number of networks 9, etc. present between the management device 1 and the devices 8. In the example illustrated in FIG. 8, the management device 1 searches the devices 8 belonging to each of the groups in ascending order of the number of networks 9, etc. present between the management device 1 and the devices 8 in the group. Thus, the management device 1 searches the devices 8 belonging to each of the groups in the order from the group 1 to the group 5.

The management device 1 may search the devices 8 in descending order of the number of networks 9, etc. present between the management device 1 and the devices 8; it is, however, more efficient to search the devices 8 in ascending order of the number of networks 9, etc. present between the management device 1 and the devices. This is because, in the case where the devices 8 are searched in descending order of the number of networks 9, etc. present between the management device 1 and the devices, information on the networks 9 and the devices 8 connected ahead of devices 8 present between a plurality of networks 9, needs to be acquired from the devices 8 intermediate between the networks 9.

In searching the devices 8, the management device 1 obtains the paths from the management device 1 to the devices 8 to be searched by using the setting information of the subject device to be connected with the management device 1. When searching for a device 8, the management device 1 sets a time for the search. If a device 8 is not found within the set time for search, the management device 1 terminates the search assuming that the device 8 that is not found is not present in the networks 9. When the management device 1 has found the subject device 8, this means that the following condition is met. A signal for search transmitted from management device 1 has reached the subject device 8 via the networks 9 and the devices 8 present between the management device 1 and the subject device 8, and a response from the subject device 8 has reached the management device 1 via the devices 8 and the networks 9.

In searching the devices 8, the management device 1 first sets the devices 8df and 8ds that are directly connected with the management device 1 as search targets. When the subject device 8 to be found is the device 8ds, the management device 1 transmits a search command 1BC including the device-specific information 31A acquired from the subject device 8ds to the devices 8df and 8ds that are directly connected with the management device 1. The device 8ds, which is directly connected with the management device 1, then sends a response 8IC to the management device 1. The response 8IC from the device 8ds includes the address of the device 8ds as the connection information 31C. The management device 1 acquires the information on the path from the management device 1 to the device 8ds, that is, the information that the device 8ds is directly connected with the management device 1, and the address of the device 8ds. Thus, the management device 1 acquires, from the information on the path, the path from the management device 1 to the device 8ds and acquires, from the address, the location where the device 8ds is connected.

If the subject device 8 is not found among the devices 8df and 8ds that are directly connected with the management device 1, the management device 1 sets, as search targets, the devices 8fs, 8sd, and 8td connected with the network 9f that is directly connected with the management device 1. When the subject device 8 to be found is the device 8sd, the management device 1 cannot find the subject device 8sd among the devices 8df and 8ds that are directly connected with the management device 1. Thus, the management device 1 transmits a search command 1BC including the device-specific information 31A acquired from the subject device 8sd to the devices 8fs, 8sd, and 8td that are connected with the network 9f that are directly connected with the management device 1.

The device 8sd connected with the network 9f then transmits a response 8IC to the management device 1. The response 8IC from the device 8sd includes the address of the device 8sd as the connection information 31C. The management device 1 acquires the information on the path from the management device 1 to the device 8sd, that is, the information that the device 8sd is connected with the network 9f that is directly connected with the management device 1, and the address of the device 8sd. Thus, the management device 1 acquires, from the information on the path, the path from the management device 1 to the device 8sd, and acquires, from the address, the location where the device 8sd is connected.

If the subject device 8 is not found among the devices 8 that are directly connected with the management device 1 and the networks 9 that are directly connected with the management device 1, the management device 1 sets, as search targets, devices 8 and networks 9 that are indirectly connected with the management device 1 via devices 8. In this case, the management device 1 acquires information on the devices 8 and the networks 9 that are connected with the devices 8fs, 8sd, and 8td, which are connected with the network 9f that is directly connected with the management device 1, from the devices 8fs, 8sd, and 8td. Examples of the information include the addresses of the devices 8 and the networks 9.

In the example illustrated in FIG. 8, the device 8fs connected with the network 9f is connected with the network 9s, and the device 8td is connected with the network 9t. Upon receiving an instruction requesting information on the connected devices and networks from the management device 1, the devices 8fs and 8td transmit the fact that each of the device 8fs or 8td is connected with the corresponding one of network 9s or 9t to the management device 1, respectively. Upon receiving the information on the connected devices and networks from each of the devices 8fs and 8td, the management device 1 searches the connected devices and networks of the devices 8fs and 8td.

When the subject device 8 to be found is the device 8ft, the management device 1 cannot find the subject device 8ft among the devices 8df and 8ds and the network 9f that are directly connected with the management device 1. Thus, the management device 1 transmits a search command 1BC including the device-specific information 31A acquired from the subject device 8ft to the devices 8ft and 8fi in the network 9s that is connected with the management device 1 via the device 8fs.

The device 8ft connected with the network 9s then transmits a response 81C to the management device 1. The response 81C from the device 8ft includes the address of the device 8ft as the connection information 31C. The management device 1 acquires information on the path that is, the information that the network 9f directly connected with the management device 1, the device 8fs connected with the network 9f, and the network 9s connected with the device 8fs are present on the path from the management device 1 to the device 8ft, and the address of the device 8ft. Thus, the management device 1 acquires, from the information on the path, the path from the management device 1 to the device 8ft, and acquires, from the address, the location where the device 8ft is connected.

When the subject device 8 is the device 8si, the management device 1 cannot find the subject device 8si in the network 9s connected with the management device 1 via the network 9f and the device 8fs. Thus, the management device 1 transmits, via the device 8td, a search command 1BC including the device-specific information 31A acquired from the subject device 8si to the devices 8si and 8sv in the network 9t connected with the management device 1.

The device 8si connected with the network 9t then transmits a response 8IC to the management device 1. The response 8IC from the device 8si includes the address of the device 8si as the connection information 31C. The management device 1 acquires information on the path that is, the information that the network 9f directly connected with the management device 1, the device 8td connected with the network 9f, and the network 9t connected with the device 8td are present on the path from the management device 1 to the device 8si, and the address of the device 8si. Thus, the management device 1 acquires, from the information on the path, the path from the management device 1 to the device 8si, and acquires, from the address, the location where the device 8si is connected.

When the subject device 8 is the device 8sw, the management device 1 cannot find the subject device 8sw in the network 9t connected with the management device 1 via the network 9f and the device 8td. Thus, the management device 1 acquires information on the connected devices and networks from each of the devices 8si and 8sv connected with the network 9t. In the example illustrated in FIG. 8, the information on the connected devices and networks is acquired only from the device 8sv. Upon receiving the information on the connected devices and networks from the device 8sv, the management device 1 searches the connected devices and networks of the device 8sv.

In the search, the management device 1 transmits a search command 1BC including the device-specific information 31A acquired from the subject device 8sw to the device 8sw via the network 9f, the device 8td, the network 9t, and the device 8sv. The device 8sw connected with the device 8sv then transmits a response 8IC to the management device 1. The response 8IC from the device 8sw includes the address of the device 8sw as the connection information 31C. The management device 1 acquires information on the path that is, the information that the network 9f directly connected with the management device 1, the device 8td connected with the network 9f, the network 9t connected with the device 8td, and the device 8sv connected with the network 9t are present on the path from the management device 1 to the device 8sw, and the address of the device 8sw. Thus, the management device 1 acquires, from the information on the path, the path from the management device 1 to the device 8sw, and acquires, from the address, the location where the device 8sw is connected.

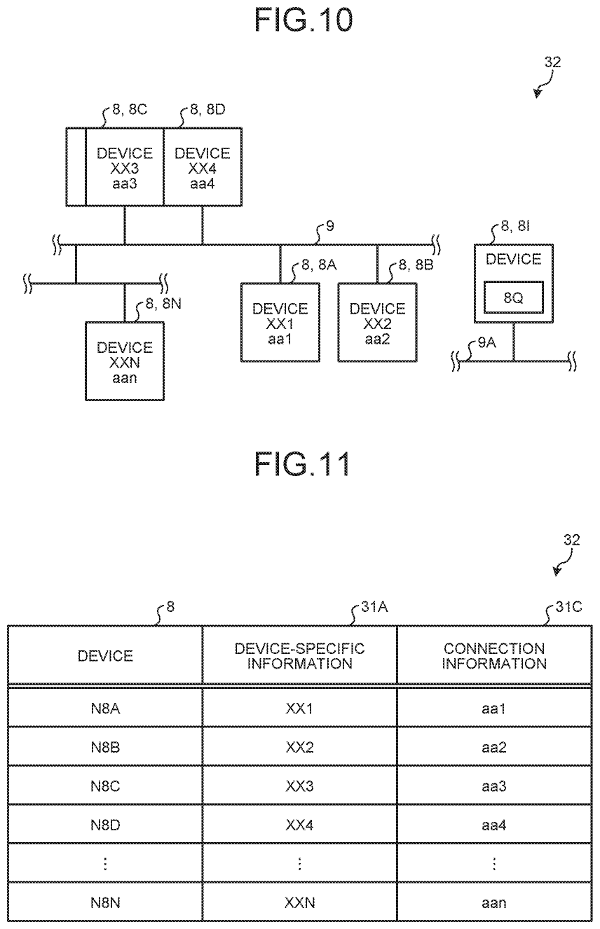

When the subject device 8 is found, the management device 1 stores the tree structure TSR illustrated in FIG. 9 into the storage unit 3. The tree structure TSR enables the management device 1 to know the path from the subject device 8 to the management device 1. Specifically, it can be seen that, when the subject device 8 is the device 8sw, the path from the management device 1 to the subject device 8sw is a path passing through the device 8td and the device 8sv. It can be seen that, when the device 8si is the subject device 8, the path from the management device 1 to the subject device 8si is a path passing through the device 8td. As described above, the management device 1 searches for the subject device 8, creates the tree structure TSR upon finding the subject device 8, and stores the tree structure TSR in the storage unit 3. The management device 1 can acquire the connection information 31C of each of the devices 8fs, 8sd, 8td, 8ft, 8fi, 8si, 8sv, 8sw, 8df, and 8ds connected with the networks 9f, 9s, and 9t (see FIG. 10) by using the tree structure TSR.

In the search process, the management unit 22 of the management device 1 illustrated in FIG. 1, or more specifically, the connection unit 22A of the management unit 22 generates a search command 1BC illustrated in FIG. 8. The connection setting unit 22A transmits the search command 1BC via the devices 8 connected with the networks 9 via the networks 9. The search command 1BC includes instructions for acquiring the address of the destination, the device-specific information 31A, and the connection information 31C of each of the devices 8. The address of the destination may be a broadcast address, which refers to a whole network 9, or may be the address of a device 8 that the user wants to check or add when the address is known.

When the communication unit 8T of the device 8 illustrated in FIG. 2 has received a search command 1BC illustrated in FIG. 8, the processing unit 8P of the device 8 compares the device-specific information 31A stored in the storage unit 8M of the device 8 with the device-specific information 31A included in the search command 1BC. When the former matches with the latter, the processing unit 8P transmits a response 8IC to the management device 1. When the former does not match with the latter, processing unit 8P terminates the process. In this case, the processing unit 8P does not transmit a response 8IC to the management device 1.

In the example illustrated in FIG. 7, the search command 1BC is transmitted to all the devices 8A, 8B, and 8C connected with the network 9. Because the search command 1BC transmitted from the management device 1 includes the device-specific information 31A of the device 8A, the processing unit 8P of the device 8A transmits a response 8IC to the management device 1. The processing units 8P of the devices 8B and 8C do not transmit responses 8IC to the management device 1.

The response 8IC includes the device-specific information 31A of the device 8 and the connection information 31C of the device 8. The device-specific information 31A and the connection information 31C included in the response 8IC are information on one device 8. The management device 1 acquires the device-specific information 31A and the connection information 31C of the device 8 when receiving the response 8IC. In the example illustrated in FIG. 7, the response 8IC is transmitted only from the device 8A. Because the device-specific information 31A and the connection information 31C of the device 8A are included in the response 8IC, the management device 1 can acquire the device-specific information 31A and the connection information 31C of the device 8A.

The management device 1 uses the device-specific information 31A received from the device 8A as a key to compare the connection information 31C received from the device 8A with the connection information 31C of the device 8A managed by the management device 1, that is, the connection information 31C stored in the storage unit 3 at this time. When the former differs from the latter, the management device 1 updates the association between the device-specific information 31A of the device 8A and the connection information 31C managed by the management device 1.

More specifically, the management device 1 associates the device-specific information 31A of the device 8A managed by the management device 1 with the connection information 31C received from the device 8A, and stores the association in the storage unit 3. In other words, the management unit 22 replaces the connection information 31C of the device 8A managed by the management device 1 with the connection information 31C of the device 8A acquired by the information acquisition unit 21.

The option setting unit 22C informs the user of the device 8A with the updated association between the device-specific information 31A and the connection information 31C. In this case, the option setting unit 22C displays, on the display unit 5, the device 8A, that is, the device 8 associated with the connection information 31C acquired by the information acquisition unit 21 in a mode different from the other components via the output control unit 23 as described above.

When the connection information 31C received from the device 8A, that is, the connection information 31C acquired by the information acquisition unit 21 is identical to the connection information 31C of the device 8A managed by the management device 1, the association between the device-specific information 31A and the connection information 31C of the device 8A managed by the management device 1 is maintained. In this case, the option setting unit 22C informs the user that there is no change in the association between the device-specific information 31A and the connection information 31C. An example of the method for informing the user is a method in which the option setting unit 22C displays, via the output control unit 23, the information that the device 8A is properly connected on the display unit 5. An example of the method for informing the user is a method in which the option setting unit 22C displays, in the configuration diagram, the device 8A associated with the connection information 31C acquired by the information acquisition unit 21 in a mode different from the other components.

When the information acquisition unit 21 cannot acquire the connection information 31C of the device 8A, the management unit 22 informs the user that the connection information 31C cannot be acquired. Next, a change in the configuration information 32 in a case where the management device 1 has performed the management method according to the first embodiment will be explained.

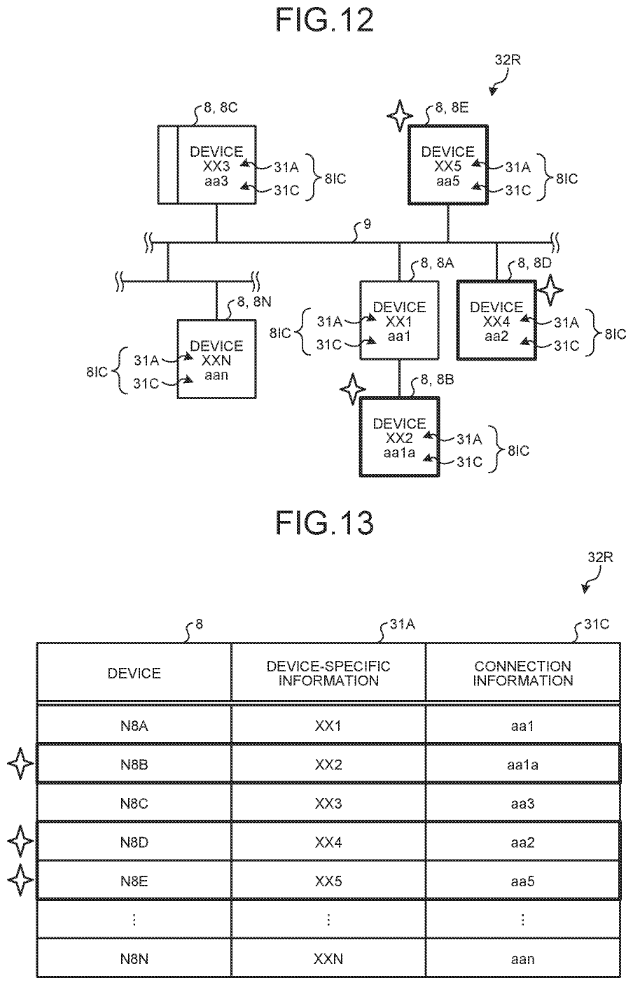

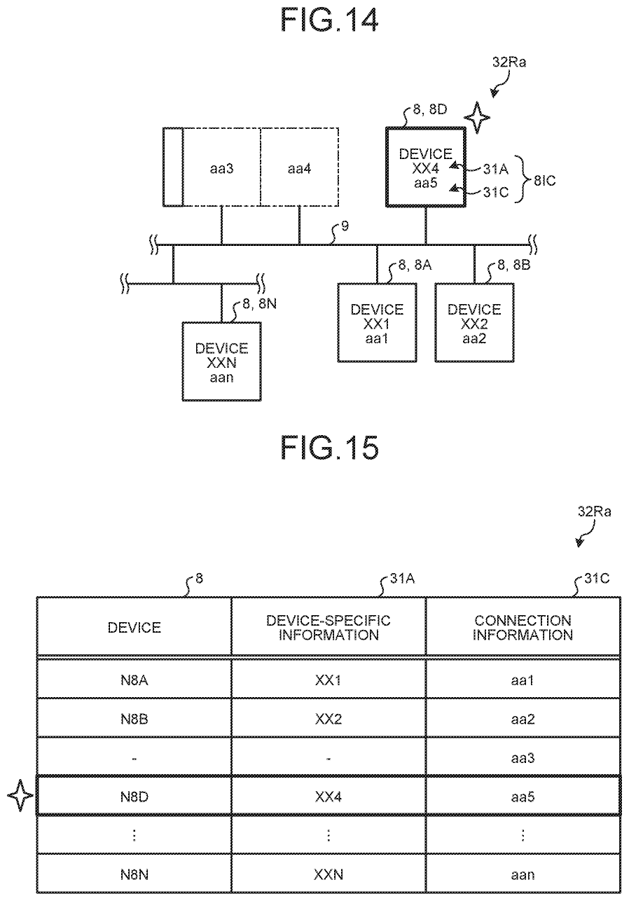

FIG. 10 illustrates the configuration information 32 according to the first embodiment in a form of a diagram. FIG. 11 illustrates the configuration information 32 according to the first embodiment in a form of a table. FIGS. 12 and 14 illustrate updated configuration information 32R and 32Ra, respectively, according to the first embodiment in a form of a table. FIGS. 13 and 15 illustrate the updated configuration information 32R and 32Ra, respectively, according to the first embodiment in a form of a table. In these examples, the configuration information 32 includes the images or the names of the devices 8 in the configuration diagram, the device-specific information 31A, and the connection information 31C associated with each other as illustrated in FIG. 11. The names of the devices 8 are devices N8A, N8B, N8C, N8D, . . . , N8N in this example. Both of the cases where the configuration information 32 and the configuration information 32R are illustrated in the form of diagrams and in the form of tables correspond to that the configuration information 32 and the configuration information 32R are illustrated in the form of configuration diagrams.

The configuration information 32 illustrated in FIGS. 10 and 11 is managed by the management device 1. The configuration information 32R illustrated in FIGS. 12 and 13 is obtained by update of the configuration information 32 managed by the management device 1 as a result of a change in the devices 8 included in the equipment 100 illustrated in FIG. 1. The configuration information 32 represents the configuration of the equipment 100 in which devices 8A, 8B, 8C, 8D, . . . , 8N are connected with the network 9. Although not included in the configuration information 32, a device 81 is connected with a network 9A that is included in equipment that is different from the equipment including the network 9.

In the configuration information 32, the device-specific information 31A and the connection information 31C of the device 8A are XX1 and aa1, respectively, the device-specific information 31A and the connection information 31C of the device 8B are XX2 and aa2, respectively, the device-specific information 31A and the connection information 31C of the device 8C are XX3 and aa3, respectively, and the device-specific information 31A and the connection information 31C of the device 8D are XX4 and aa4, respectively. The device-specific information 31A and the connection information 31C of the device 8N are XXN and aan, respectively.

The configuration information 32 is set before operation of the equipment 100. Assume a case where the device 8B and the device 8D are replaced with each other and a device 8E is further connected with the network 9 as illustrated in FIGS. 12 and 13 from this state. In this case, the associations between the device-specific information 31A and the connection information 31C of the devices 8B and 8D managed by the management device 1 are different from the actual associations between the device-specific information 31A and the connection information 31C of the devices 8B and 8D. Thus, the management device 1 illustrated in FIG. 1 performs the management method according to the first embodiment to match the associations managed by the management device 1 with the actual associations in the equipment 100.

The user sequentially takes images of the identification information transfer parts 8Q of the devices 8A, 8B, 8C, 8D, 8E, . . . , 8N included in the current equipment 100 illustrated in FIGS. 12 and 13 using the portable terminal device 7 illustrated in FIG. 1. The portable terminal device 7 transmits an analysis result 7R of the identification information transfer parts 8Q illustrated in FIG. 7 to the management device 1. Upon receiving the analysis result 7R from the portable terminal device 7, the management device 1 transmits a search command 1BC illustrated in FIG. 7 to the whole network 9. The devices 8A, 8B, 8C, 8D, 8E, . . . , 8N, in receipt of the search command 1BC, each transmit a response 8IC including the connection information 31C (see FIG. 7) to the management device 1 when the devices 8A, 8B, 8C, 8D, 8E, . . . , 8N include the same device-specific information 31A as the device-specific information 31A included in the search command 1BC. The management device 1 updates the associations between the device-specific information 31A and the connection information 31C of the devices 8 managed by the management device 1 illustrated in FIG. 7 on the basis of the responses 8IC.

The responses 8IC including the device-specific information 31A and the connection information 31C of the devices 8B and 8D are transmitted from the devices 8B and 8D, respectively, to the management device 1. The storage unit 3 of the management device 1 has the device-specific information 31A, the control information 31B, and the connection information 31C of each of the devices 8B and 8D. As illustrated in FIGS. 11 and 13, however, the associations between the device-specific information 31A and the connection information 31C of the devices 8B and 8D managed by the management device 1 are different from the actual associates between the device-specific information 31A and the connection information 31C of the devices 8B and 8D. When the associations between the device-specific information 31A and the connection information 31C of the devices 8B and 8D managed by the management device 1 are different from the information received from the devices 8B and 8D as described above, the management device 1 determines that connection points of the devices 8B and 8D are changed or incorrect. The management device 1 updates the associations between the device-specific information 31A and the connection information 31C of the devices 8B and 8D.

The responses 8IC including the device-specific information 31A and the connection information 31C of the devices 8A, 8C, and 8N are transmitted from the devices 8A, 8C, and 8N, respectively, to the management device 1. As illustrated in FIGS. 11 and 13, the associations between the device-specific information 31A and the connection information 31C of the devices 8A, 8C, and 8N managed by the management device 1 are the same as the actual associations between the device-specific information 31A and the connection information 31C of the devices 8A, 8C, and 8N. When the associations between the device-specific information 31A and the connection information 31C of the devices 8A, 8C, and 8N managed by the management device 1 are the same in this manner, the management device 1 determines that there has been no change in the connection points of the devices 8A, 8C, and 8N.

The device 8E illustrated in FIG. 12 is newly added to the network 9 of the equipment 100. A response 8IC including the device-specific information 31A and the connection information 31C of the device 8E is transmitted from the device 8E to the management device 1 illustrated in FIG. 7. The storage unit 3 of the management device 1 does not have the device-specific information 31A, the control information 31B, and the connection information 31C of the device 8E. In addition, the device-specific information 31A of the device 8E is not present in the configuration information 32, either. When the device-specific information 31A and the connection information 31C included in the response 8IC transmitted from the device 8E are not present in the storage unit 3 of the management device 1 in this manner, the management device 1 determines that the device 8E is newly added to the network 9. In this case, the management device 1 adds the device 8E to the configuration information 32, and associates the device 8E with the device-specific information 31A and the connection information 31C of the device 8E. In the first embodiment, adding the new device 8E to the configuration information 32 and associating the information also correspond to the update of the associations between the device-specific information 31A and the connection information 31C of the devices 8.

The device 81 illustrated in FIG. 10 is connected with a network 9A that is different from the network 9 and that is not connected with the network 9. In a case where the portable terminal device 7 illustrated in FIG. 7 takes an image of the identification information transfer part 8Q of the device 81 and transmits an analysis result 7R to the management device 1, and the management device 1 transmits a search command 1BC to the whole network 9, the search command 1BC does not reach the devices 81 that is not connected with the network 9A. Thus, the response 8IC illustrated in FIG. 7 is not returned to the management device 1. In the case where no response 8IC is returned after the management device 1 has transmitted a search command 1BC for the device 81, it can be determined that the device 81 is not present in the network 9.

The configuration information 32Ra illustrated in FIGS. 14 and 15 presents a state in which the device 8C has been removed from the network 9 and a connection point of the device 8D has been changed from the configuration information 32 illustrated in FIGS. 10 and 11. In this case, because there is no response 8IC from the device 8C to the search command 1BC based on the device identification information 31U of the device 8C, the management device 1 determines that the device 8C is not present in the network 9. Because the device 8D is connected with the network 9, a response 8IC to a search command 1BC (see FIG. 7) based on the device identification information 31U (see FIG. 2) of the device 8D is returned from the device 8D. The association between the device-specific information 31A and the connection information 31C of the device 8D managed by the management device 1 illustrated in FIG. 7 is different from the actual association between the device-specific information 31A and the connection information 31C of the device 8D. In this case, the management device 1 determines that a connection point of the device 8D has changed, and updates the association between the device-specific information 31A and the connection information 31C of the device 8D.

In the configuration information 32R resulting from the update, the connection information 31C of the device 8B is updated with aa1a, the connection information 31C of the device 8D is updated with aa2, and XX5 that is the device-specific information 31A of the device 8E and aa5 that is the connection information 31C of the device 8E are added as illustrated in FIGS. 12 and 13. The management device 1 illustrated in FIG. 7 displays the devices 8B and 8D the information of which are updated and the added device 8E in a mode different from the other devices 8A, 8C, and 8N in the configuration diagram or the table of the configuration information 32R displayed on the display unit 5 illustrated in FIG. 7. In the example illustrated in FIGS. 12 and 13, displaying in a different mode means displaying the devices 8B and 8D the information of which are updated and the added device 8E in a highlighted state or in an illuminated state.

### Procedures of Processing of Management Device 1

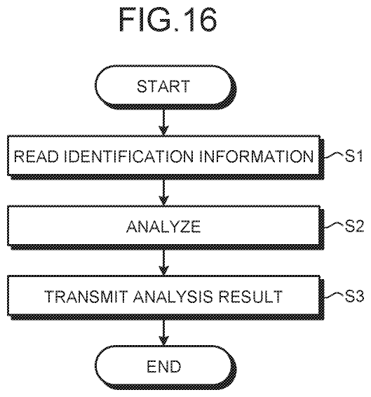

FIG. 16 is a flowchart illustrating an example of processing performed by a portable terminal device 7 according to the first embodiment. In a case where a user wants to check the connection state of a device 8 or wants to newly add a device 8 among the devices 8 of the equipment 100 illustrated in FIG. 1, the portable terminal device 7 illustrated in FIG. 1 first reads the identification information transfer part 8Q of the device 8 according to the operation of the user (step S1). More specifically, upon receiving an input from the user requesting to read the identification information, the input unit 7D informs the reading unit 7C of the same. The reading unit 7C images an area including the identification information transfer part 8Q in which the device identification information 31U illustrated in FIG. 2 is embedded, and inputs image data obtained by imaging to the analysis unit 7B.

Subsequently, the analysis unit 7B illustrated in FIG. 1 analyzes the image data of the read identification information transfer part 8Q (step S2). The analysis unit 7B analyzes the image data of the identification information transfer part 8Q and obtains the device identification information 31U. The communication unit 7A illustrated in FIG. 1 transmits an analysis result 7R (see FIG. 7) obtained by the analysis by the analysis unit 7B, that is, the device identification information 31U (see FIG. 2) to the management device 1 (step S3). The analysis result 7R, that is, the device identification information 31U transmitted from the portable terminal device 7 is transmitted to the management device 1 via radio communication.

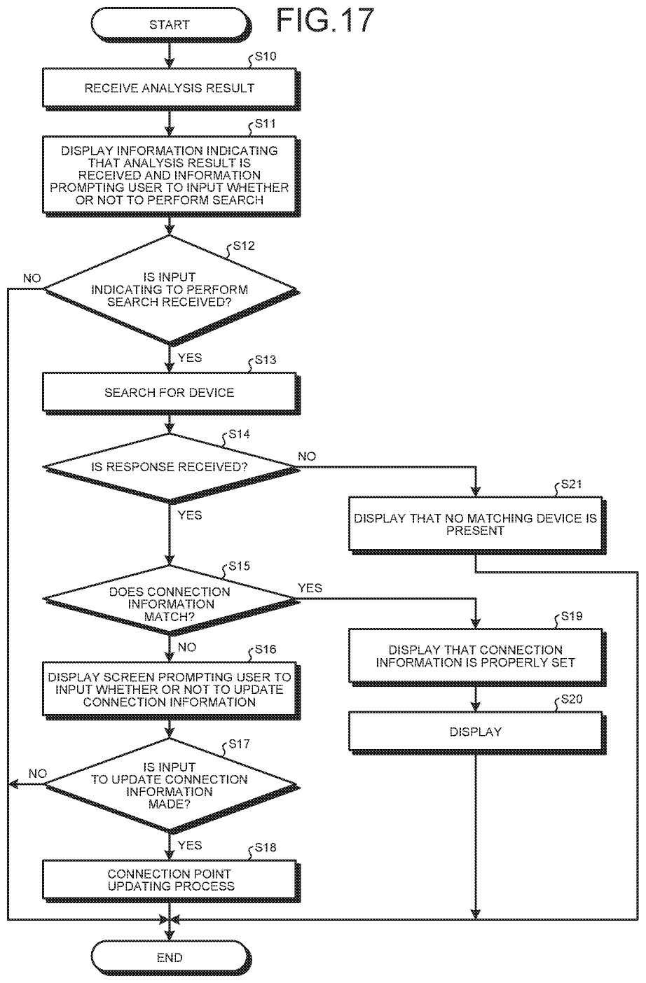

FIG. 17 is a flowchart illustrating an example of procedures in a case where the management device 1 according to the first embodiment has received the analysis result 7R from the portable terminal device 7. First, the communication unit 4A of the reception unit 4 of the management device 1 illustrated in FIG. 1 receives the analysis result 7R, that is, the device identification information 31U (see FIGS. 1 and 2) from the portable terminal device 7 (step S10). The connection setting unit 22A of the management device 1 obtains the connection information 31C from the device identification information 31U received by the reception unit 4, and stores the connection information 31C in the storage unit 3. As a result of this process, the device 8 that the user wants to check or add is identified by the connection setting unit 22A.

Subsequently, the management device 1 displays information indicating that the device identification information 31U is received and information prompting the user to input whether or not to perform search (step S11). More specifically, the communication unit 4A of the management device 1 informs the output control unit 23 that the device identification information 31U is received. The output control unit 23 displays, on the display unit 5, the information indicating that the device identification information 31U is received and the information prompting the user to input whether or not to perform search.

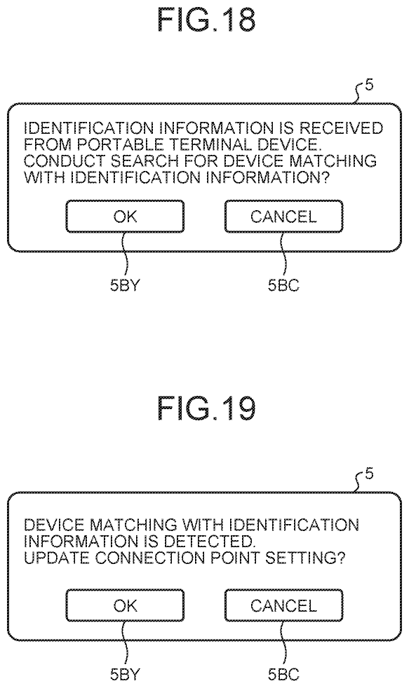

FIG. 18 is a diagram illustrating an example of a display screen displaying the information indicating that the device identification information 31U is received and the information prompting the user to input whether or not to perform search in the first embodiment. In the example illustrated in FIG. 18, a text saying “CONDUCT SEARCH FOR DEVICE MATCHING WITH IDENTIFICATION INFORMATION?” together with an OK button 5BY and a cancel button 5BC are displayed as the information prompting the user to input whether or not to perform the search on the screen of the display unit 5. The display screens described below including FIG. 18 are examples, and the actual display screens are not limited to those illustrated.

The description refers back to FIG. 17, in which the management device 1 illustrated in FIG. 1 determines whether or not an input indicating to perform the search is received (step S12). More specifically, the connection setting unit 22A determines whether the OK button 5BY or the cancel button 5BC illustrated in FIG. 18 is pressed via the input unit 4B. If an input indicating to perform the search is not received, that is, if the cancel button 5BC is pressed (step S12, No), the management device 1 terminates the process.

If an input indicating to perform the search is received, that is if the OK button 5BY illustrated in FIG. 18 is pressed (step S12, Yes), the connection setting unit 22A in the management device 1 searches for the device 8 associated with the device identification information 31U received in step S10 (step S13).

More specifically, the connection setting unit 22A transmits a search command 1BC illustrated in FIG. 7 with respect to the device identification information 31U received in step S10. The search command 1BC enables the connection setting unit 22A to acquire the actual connection state of the device 8 associated with the device identification information 31U. In other words, the connection setting unit 22A acquires the connection information 31C that is information indicating the connection state of the device 8 associated with the device identification information 31U by using the device identification information 31U acquired by the communication unit 4A.

The connection setting unit 22A determines whether or not a response 8IC illustrated in FIG. 7 is received in response to the search command 1BC transmitted on the basis of the device identification information 31U received in step S10 (step S14). This determination is made on whether or not the device 8 matching with the device identification information 31U, or more specifically, the device-specific information 31A received instep S10 is present in the network 9.

If the response 8IC is received (step S14, Yes), the connection setting unit 22A determines that the device 8 matching with the device identification information 31U received in step S10 is present in the network 9. In step S15, the connection setting unit 22A refers to the identification information 31 stored in the storage unit 3 for the connection information 31C associated with the device-specific information 31A of the device identification information 31U received in step S10. The connection setting unit 22A then determines whether or not the connection information 31C of the device 8 acquired by the search matches with the connection information 31C stored in the storage unit 3 and associated with the device 8 acquired by the search (step S15).

In this determination, the connection setting unit 22A uses the device-specific information 31A of the device identification information 31U received in step S10 as a key to search for the connection information 31C of identification information 31 stored in the storage unit 3. If the connection information 31C stored in the storage unit 3 matches with the connection information 31C of the device identification information 31U received in step S10, the connection setting unit 22A then determines that the former matches with the latter. If the connection information 31C stored in the storage unit 3 does not match with the connection information 31C of the device identification information 31U received in step S10, the connection setting unit 22A determines that the former does not match with the latter.

If the connection information 31C stored in the storage unit 3 does not match with the connection information 31C of the device identification information 31U received in step S10 (step S15, No), the management device 1 displays a screen prompting the user to input whether or not to update the connection information 31C (step S16). More specifically, the connection setting unit 22A instructs the output control unit 23 to display a screen prompting the user to input whether or not to update the connection information 31C. The output control unit 23 displays the screen prompting the user to input whether or not to update the connection information 31C on the display unit 5.

FIG. 19 is a diagram illustrating an example of the screen prompting the user to input whether or not to update the connection information 31C in the first embodiment. In the example illustrated in FIG. 19, the information prompting the user to input whether or not to update the connection information 31C illustrated in FIG. 1 is displayed, together with the information indicating that the device 8 matching with the device-specific information 31A of the device identification information 31U illustrated in FIG. 1 is detected as a result of the search. In the example illustrated in FIG. 19, a text saying “UPDATE CONNECTION POINT SETTING?” together with an OK button 5BY and a cancel button 5BC are displayed on the screen of the display unit 5 to prompt the user to input.

Subsequently, the connection setting unit 22A determines whether or not an input to update the connection information 31C stored in the storage unit 3 of the management device 1 illustrated in FIG. 1 is made (step S17). More specifically, the connection setting unit 22A determines whether the OK button 5BY or the cancel button 5BC illustrated in FIG. 19 is pressed via the input unit 4B.

If information to update the connection information 31C is input (step S17, Yes), the management device 1 illustrated in FIG. 1 performs a process of updating the connection point (step S18), and then terminates the process. The process of updating the connection point is a process of updating the connection information 31C and the configuration information 32 stored in the storage unit 3 on the basis of the device identification information 31U obtained as a result of the search, generating a configuration diagram based on the updated configuration information 32, and displaying the configuration diagram on the display unit 5. Thus, if the connection information 31C obtained as a result of the search is different from the connection information 31C stored in the storage unit 3, the connection setting unit 22A updates the connection information 31C stored in the storage unit 3 on the basis of the connection information 31C obtained as a result of the search.

More specifically, as the process of updating the connection point, the connection setting unit 22A updates, with the connection information 31C obtained as a result of the search, the connection information 31C associated with the device-specific information 31A of the device 8 for which the connection information 31C is to be updated among the connection information 31C of the devices 8 stored in the storage unit 3. When the connection information 31C is updated, the configuration setting unit 22B modifies the configuration information 32 in the storage unit 3 on the basis of the updated connection information 31C. The configuration setting unit 22B then generates display data for displaying the configuration diagram on a screen on the basis of the configuration information 32 and the device-specific information 31A in the storage unit 3 and the updated connection information 31C, and passes the display data to the output control unit 23. The output control unit 23 displays the display data on the screen of the display unit 5. In this process, the option setting unit 22C displays the device 8 for which the connection information 31C is updated in a mode different from the other devices 8 in the configuration diagram, so as to inform the user of the device 8 the connection information 31C of which is updated.

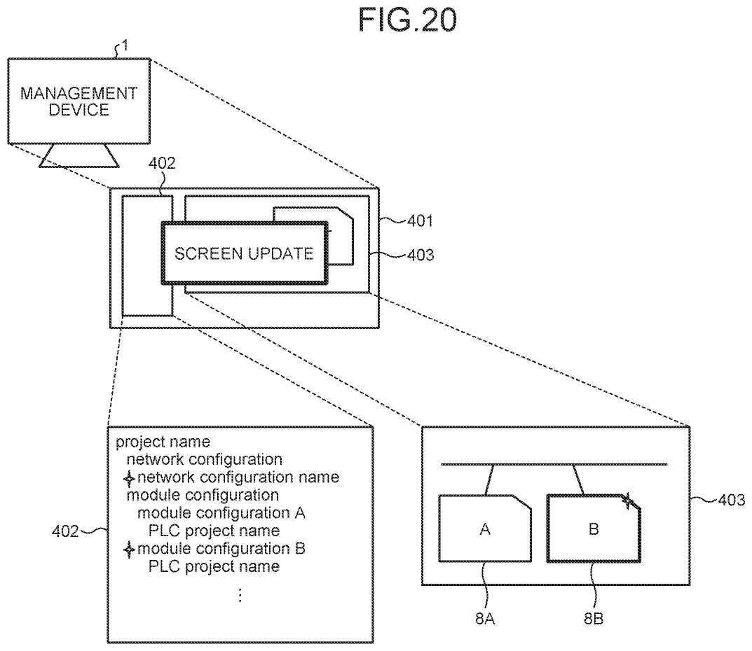

FIG. 20 is a diagram illustrating an example of a display screen of a configuration diagram in the first embodiment. A configuration diagram display screen 401 in FIG. 20 is a screen displayed on the display unit 5. The configuration diagram display screen 401 includes a tree display part 402 and a system-configuration-diagram-display-part 403.

The tree display part 402 includes a system configuration name (corresponding to a project name), the type of the configuration diagram (corresponding to network/module configuration), a configuration diagram name (corresponding to a network/module configuration name), and a project name (corresponding to a PLC project name). The tree display part 402 presents the relation in each configuration diagram, that is, the type and the information included therein. Thus, the configuration information 32 needs information in the configuration diagram itself and information on the tree display part 402.

In the example illustrated in FIG. 20, the project name (PLC project name) is first displayed in the tree display part 402. The project name is a name for identifying the equipment 100. Configurations are displayed under the project name. The configurations include a network configuration and a module configuration. The network configuration includes a network configuration name. A module configuration of each module is displayed as the module configuration.

In the example illustrated in FIG. 20, a module configuration A that is a module configuration of the device 8A illustrated in FIG. 1 and a module configuration B that is a module configuration of the device 8B illustrated in FIG. 1 are displayed. Herein, the name of the device 8A is A, and the name of the device 8B is B. In FIG. 20, a text displayed as the tree display part 402 is data for drawing the system-configuration-diagram-display-part 403, which are data corresponding to the configuration information 32 stored in the storage unit 3.

Module configurations of each device 8 include the control information 31B and the connection information 31C that are stored in the storage unit 3 illustrated in FIG. 1. Thus, the tree display part 402 is displayed on the basis of the identification information 31 stored in the storage unit 3. In the tree display part 402, a portion that is updated as a result of search, that is, the network configuration name and the module configuration B in FIG. 20 are displayed in a mode different from the remaining portion. Cross marks illustrated in FIG. 20 mean that the network configuration name and the module configuration B are illuminated.

In this example, because the connection information 31C of the device 8B illustrated in FIG. 1 is updated as a result of the search process described above, the module configuration B corresponding to the device 8B is displayed in a mode different from the other configurations. In addition, because the connection point of the device 8B has been changed, the network configuration name is also changed.

In addition, in the example illustrated in FIG. 20, a system configuration diagram in a form of a tree is displayed in the system-configuration-diagram-display-part 403. The system-configuration-diagram-display-part 403 is displayed on the basis of the configuration information 32 in the storage unit 3, and a portion updated as a result of the search, that is, the component associated with the device identification information 31U acquired by the communication unit 4A is displayed in a mode different from the other components, in a manner similar to the tree display part 402. In the example illustrated in FIG. 20, the device 8B is displayed in a mode different from the device 8A.

The description refers back to FIG. 17, in which if no input to update the connection information 31C illustrated in FIG. 1 is made (step S17, No), that is, if the connection setting unit 22A detects that the cancel button 5BC is pressed by the user, the process is terminated.

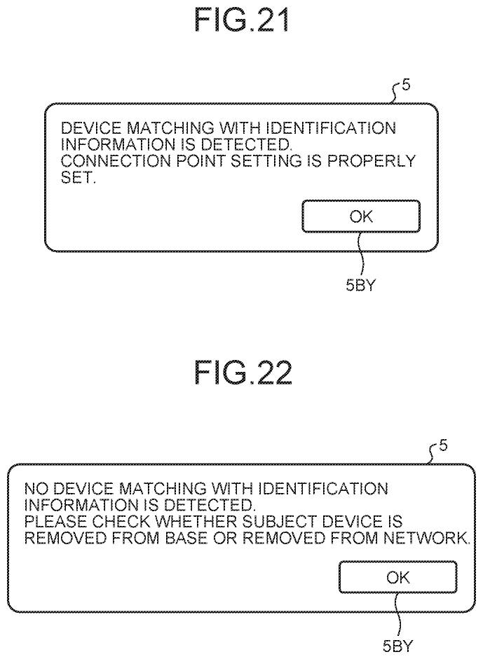

FIG. 21 is a diagram illustrating an example of a screen indicating that the connection information 31C is properly set in the first embodiment. An OK button 5BY is displayed on the screen indicating that the connection information 31C illustrated in FIG. 1 is properly set. If the connection information 31C obtained as a result of the search matches with the connection information 31C stored in the storage unit 3 (step S15, Yes), the management device 1 displays the screen indicating that the connection information 31C is properly set (step S19).

Upon detecting that the OK button 5BY on the screen displayed in step S19 is pressed, the management device 1 illustrated in FIG. 1 displays the tree display part 402 and the system-configuration-diagram-display-part 403 in the next step (step S20). An example of this display at this time is the same as the example illustrated in FIG. 20, in which the option setting unit 22C highlights the device 8 associated with the device-specific information 31A of the identification information 31. In this case, because the network configuration has not been changed, the network configuration name is not highlighted. In addition, display of a device 8 updated in the process of updating the connection point in step S18 and display of a device 8 in step S19 may be in modes different from each other by using different colors.

FIG. 22 is a diagram illustrating an example of a screen indicating that no device 8 associated with the device identification information 31U is detected in the first embodiment. The description refers back to FIG. 17 in which, if no response 8IC illustrated in FIG. 7 is received in step S14 (step S14, No), the management device 1 illustrated in FIG. 1 displays the screen indicating that no device 8 associated with the device identification information 31U is detected (step S21). The connection setting unit 22A instructs the output control unit 23 to display the screen indicating that no device 8 associated with the device identification information 31U is detected. The output control unit 23 displays, on the display unit 5, the screen indicating that no device 8 associated with the device identification information 31U is detected.

According to the operation described above, the management device 1 automatically updates the connection point of the devices 8 when a connection point of a device 8 is different or when a device 8 is newly added. As a result, the management device 1 avoids malfunction of the devices 8 caused by erroneous input of the connection points of the devices 8 or erroneous transmission of information indicating the connection points of the devices 8.

### A Case Where the User Checks the Connection State of a Device 8 After the Connection Points of the Devices 8 of the Equipment 100 are Set

The user may check the connection of a device 8 after the connection points of the devices 8 of the equipment 100 illustrated in FIG. 1 are set. In this case, the user operates the portable terminal device 7 to make the portable terminal device 7 read the identification information transfer part 8Q of the device 8. The operation of the portable terminal device 7 is as described above.

Upon receiving an analysis result 7R illustrated in FIG. 7 from the portable terminal device 7, the management device 1 searches the identification information 31 stored in the storage unit 3 and determines whether or not the connection information 31C associated with the device-specific information 31A of the device 8 is present. If the connection information 31C associated with the device-specific information 31A of the device 8 is present, the management device 1 performs a process of checking the connection state of the device 8 after the connection points of the devices 8 are set.

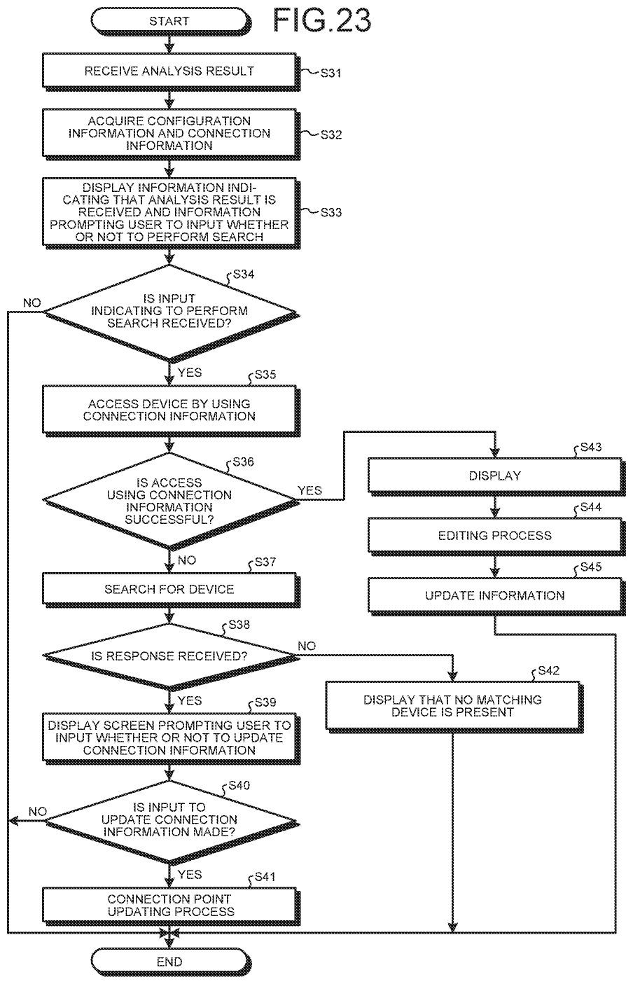

FIG. 23 is a flowchart illustrating an example of operation of the management device 1 in the case where the user checks the connection state of a device 8 after the connection points of the devices 8 of the equipment 100 are set in the first embodiment. Step S31 is similar to step S10 illustrated in FIG. 17. Upon receiving the device identification information 31U, the management device 1 illustrated in FIG. 1 uses the device-specific information 31A (see FIG. 2) of the device identification information 31U as a key to acquire the connection information 31C and the configuration information 32 from the storage unit 3 illustrated in FIG. 1 (step S32). Steps S33 and S34 are similar to steps S11 and S12 illustrated in FIG. 17.

If the determination is No in step S34, the management device 1 terminates the process. If the determination is Yes in step S34, the connection setting unit 22A of the management device 1 accesses the device 8 by using the connection information 31C acquired from the storage unit 3 (step S35). Subsequently, the connection setting unit 22A determines whether or not the access to the device 8 using the connection information 31C acquired from the storage unit 3 is successful (step S36). If the access is not successful, (step S36, No), the process proceeds to step S37. Steps S37 and S38 are similar to steps S13 and S14 illustrated in FIG. 17.

If no matching device 8 is present in step S38 (step S38, No), the management device 1 performs the process in step S42. The process in step S42 is similar to the process in step S21.

If a matching device 8 is present in step S38 (step S38, Yes), the management device 1 displays a screen prompting the user to input whether or not to update the connection information 31C in the storage unit 3 (step S39). More specifically, the connection setting unit 22A instructs the output control unit 23 to display a screen prompting the user to input whether or not to update the connection information 31C. The output control unit 23 displays the screen prompting the user to input whether or not to update the connection information 31C on the display unit 5.

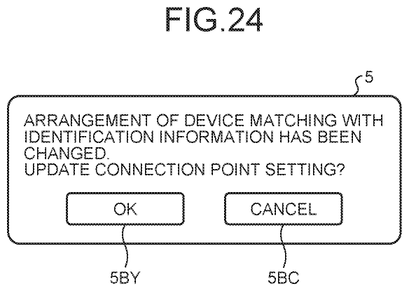

FIG. 24 is a diagram illustrating an example of the screen prompting the user to input whether or not to update the connection information 31C displayed in step S39 in the first embodiment. In the example illustrated in FIG. 24, information prompting the user to input whether or not to update the connection information 31C is displayed together with information indicating that arrangement of the device 8 matching with the device-specific information 31A has been changed. In the example illustrated in FIG. 24, a text saying “UPDATE CONNECTION POINT SETTING?” together with an OK button 5BY and a cancel button 5BC are displayed on the screen of the display unit 5 to prompt the user to input.

The connection setting unit 22A determines whether or not an input to update the connection information 31C is made (step S40). More specifically, the connection setting unit 22A illustrated in FIG. 1 determines whether the OK button 5BY or the cancel button 5BC illustrated in FIG. 24 is pressed via the input unit 4B.

If an input to update the connection information 31C is made (step S40, Yes), the management device 1 illustrated in FIG. 1 performs a process of updating the connection point similar to step S18 in step S41, and then terminates the process.

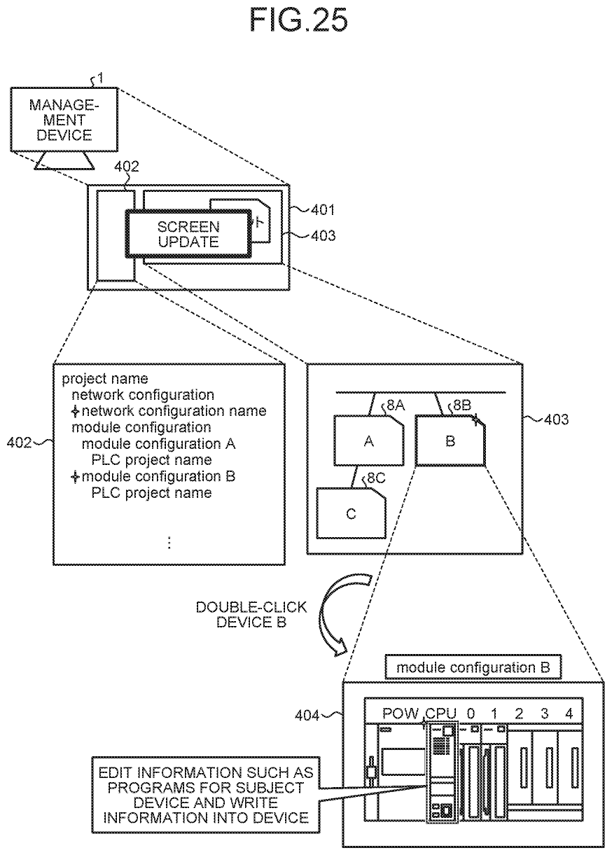

FIG. 25 is a diagram illustrating an example of a screen displayed in the process of updating the connection points in the first embodiment. In a manner similar to the screen illustrated in FIG. 20, updated portions are displayed in a mode different from the remaining portions. In this example, devices 8A, 8B, and 8C are displayed in the system-configuration-diagram-display-part 403.

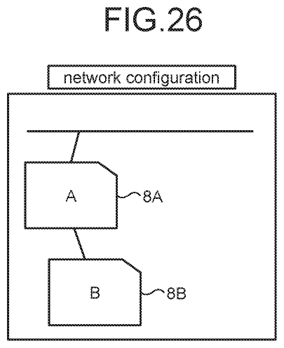

FIG. 26 is a diagram illustrating an example of the system-configuration-diagram-display-part 403 in a state before the update in the first embodiment. In a case where the actual connections of the devices 8A and 8B are as in the configuration illustrated in FIG. 26, when the user forgets to update the configuration, the configuration diagram displayed by the management device 1 will be that as illustrated in FIG. 26. In the first embodiment, as described above, when the user selects to perform the update, the management device 1 automatically updates the configuration information 32, which enables a configuration diagram matching with the actual configuration to be displayed on the screen.

The description refers back to FIG. 23, in which if no input to update the connection information is made (step S40, No), that is, if the cancel button 5BC illustrated in FIG. 24 is pressed, the management device 1 terminates the process.

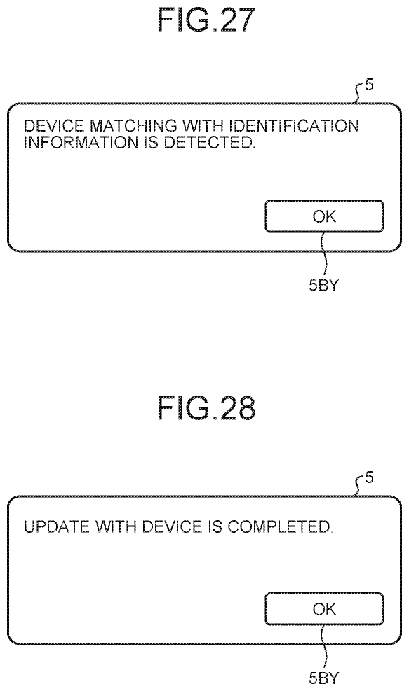

FIG. 27 is a diagram illustrating an example of a screen displaying that a device 8 matching with the connection information 31C is detected in the first embodiment. If the access to the device 8 by using the connection information 31C acquired from the storage unit 3 of the management device 1 illustrated in FIG. 1 is successful in step S36 (step S36, Yes), the management device 1 displays, on the display unit 5, the screen illustrated in FIG. 27 indicating that the device 8 matching with the connection information 31C in the storage unit 3 is detected. Thereafter, the management device 1 displays the tree display part 402 and the system-configuration-diagram-display-part 403 illustrated in FIG. 25 on the display unit 5, and displays portions corresponding to the connection information 31C acquired in step S32 in a mode different from the remaining portions (step S43).

The description refers back to FIG. 23, in which the management device 1 illustrated in FIG. 1 performs an editing process (step S44). The editing process is started when the user double-clicks a device 8 to be set in the system-configuration-diagram-display-part 403 illustrated in FIG. 25 by using the input unit 4B. The management device 1 displays a setting screen 404 (see FIG. 25) for performing various settings on the device 8 that is selected by the double-click. More specifically, upon detecting that the user has double-clicked the device to be set in the system-configuration-diagram-display-part 403 by using the input unit 4B, the configuration editing unit 22D illustrated in FIG. 1 instructs the output control unit 23 to display the setting screen 404. The output control unit 23 displays the setting screen 404 on the display unit 5 in accordance with the instruction. The user then inputs information to be set into the device 8 according to the setting screen 404 illustrated in FIG. 25.

FIG. 28 is a diagram illustrating an example of a screen indicating that update of the device 8 is completed in the first embodiment. The management device 1 illustrated in FIG. 1 performs information update on the basis of the information input in the editing process (step S45), and terminates the process. More specifically, the configuration editing unit 22D receives information necessary for the editing process input via the input unit 4B, stores the control information 31B based on the received information in the storage unit 3, and writes the received information into the device 8 via the network 9. In addition, the configuration editing unit 22D instructs the output control unit 23 to display a screen indicating that update of the device 8 is completed. The output control unit 23 displays, on the display unit 5, the screen indicating that the update of the device 8 is completed on the basis of the instruction from the configuration editing unit 22D as illustrated in FIG. 28.

As a result of the processes described above, the device 8 is set as desired by the user. Specifically, in the first embodiment, in setting the control information 31B to be set in each device 8, a displayed component associated with the device identification information 31U obtained by the communication unit 4A is displayed in a mode different from the other components on the screen of the display unit 5 illustrated in FIG. 1. The management device 1 then performs the process of receiving input and editing of the control information 31B. This enables the user to properly select the device 8 to be set by double-clicking the portion displayed in a mode different from the remaining portions in the system-configuration-diagram-display-part 403, and avoid performing setting on a wrong device 8.

In the example described above, the identification information transfer part 8Q in which the device identification information 31U is embedded is pasted on a device 8 and imaged with the portable terminal device 7, so that the portable terminal device 7 acquires the device identification information 31U of each device 8. However, the method for acquiring the device identification information 31U is not limited to this example. For example, the identification information transfer part 8Q may be a tag device, and the reading unit 7C and the analysis unit 7B of the portable terminal device 7 may have a function of a tag reader. In this manner, the portable terminal device 7 can acquire the device identification information 31U of each device 8 by radio communication.

While the portable terminal device 7 analyzes the identification information transfer part 8Q in the first embodiment, the analysis is not limited thereto. The management device 1 may acquire image data of the identification information transfer part 8Q from the portable terminal device 7 and analyze the image data of the identification information transfer part 8Q to obtain the device identification information 31U.

As described above, in the first embodiment, the management device 1 acquires the device identification information 31U of each of the devices 8 managed by the management device 1, and obtains the connection information 31C of each of the devices 8 on the basis of the device-specific information 31A included in the acquired device identification information 31U. In this manner, the management device 1 searches the network 9 for a device 8 having the device-specific information 31A, and therefore obtains correct associations between the device-specific information 31C and the connection information 31C of each of the devices 8. This prevents or reduces malfunction when the management device 1 causes the devices 8 of the equipment 100 to operate. In other words, this prevents or reduces malfunction when the devices 8 are operated on the basis of the control information 31B, which is information held by the management device 1.

The configurations presented in the embodiment above are examples of the present invention, which can be combined with other known technologies or can be partly omitted or modified without departing from the scope of the present invention.

### REFERENCE SIGNS LIST

1 management device; 1BC search command; 1D output device; 1M, 702, 802 memory; 1P, 701, 801 processor; 1R, 705, 804 input device; 1S processing circuit; 2, 8P processing unit; 3, 8M storage unit; 4 reception unit; 4A communication unit; 4B, 7D input unit; 5 display unit; 7 portable terminal device; 7A, 8T communication unit; 7B analysis unit; 7C reading unit; 7R analysis result; 8, 8A, 8B, 8C, 8D, 8E, 81, 8N device; 8IC response; 8Q identification information transfer part; 9, 9A network; 10 machine; 21 information acquisition unit; 22 management unit; 22A connection setting unit; 22B configuration setting unit; 22C option setting unit; 22D configuration editing unit; 23 output control unit; 31 identification information; 31A device-specific information; 31B control information; 31C connection information; 31U device identification information; 32, 32R, 32Ra configuration information; 100 equipment; 703 imaging device; 704, 803 communication device; 706 display device.

1-10. (canceled)

11. A management device that manages at least one device included in equipment, the management device comprising:
a processor; and
a memory to store a program which, when executed by the processor, performs processes of:
acquiring connection information indicating a connection point of a device associated with device-specific information of the device; and
providing information indicating the device associated with xe connection information acquired,
wherein the information acquiring includes searching the device having the device-specific information in an order based on at least either of a number of networks and a number of devices present between the management device and each of the devices to be searched, to acquire the connection information of the device searched.

12. The management device according to claim 11, wherein for displaying the device associated with the connection information acquired in a configuration diagram, the processor provides information on the device by displaying the device in the configuration diagram in a mode different from other devices displayed in the configuration diagram.

13. A management device that manages at least one device included in equipment, the management device comprising:
a processor; and
a memory to store a program which, when executed by the processor, performs processes of:
acquiring connection information indicating a connection point of a device associated with device-specific information of the device; and providing information indicating the device associated with the connection information acquired; wherein
the memory stores the connection information in advance,
the information acquisition includes searching the device having the device-specific information to acquire the connection information of the device searched,
for displaying the device associated with the connection information acquired in a configuration diagram, in the providing, information on the device by displaying the device in the configuration diagram is provided in a mode different from other devices displayed in the configuration diagram, and
when the connection information of the device acquired is different from the connection information stored in the memory, the processor replaces the connection information stored in the memory with the connection information of the device acquired, and displays the device associated with the connection information acquired in the configuration diagram in a mode different from other devices.

14. A management device that manages at least one device included in equipment, the management device comprising:
a processor; and
a memory to store a program which, when executed by the processor, performs processes of:
acquiring connection information indicating a connection oint of a device associated with device-specific information of the device; and
providing information indicating the device associated with the connection information acquired, wherein
the information acquisition includes searching the device having the device-specific information and acquiring the connection information of the device searched,
for displaying the device associated with the connection information acquired in a configuration diagram, in the providing, information on the device is provided by displaying the device in the configuration diagram in a mode different from other devices displayed in the configuration diagram, and
when the connection information of the device acquired is identical to the connection information stored in the memory that stores the connection information in advance, the processor displays the device associated with the connection information acquired in a mode different from other devices in the configuration diagram.

15. The management device according to claim 14 further comprising:
when the connection information of the device acquired is different from the connection information stored in the memory, the processor replaces the connection information stored in the memory with the connection information of the device acquired, and displays the device associated with the connection information acquired in the configuration diagram in a mode different from other devices.

16. The management device according to claim 11, wherein when the processor cannot acquire the connection information of the device, the processor provides information that the connection information has not been acquired.

17. The management device according to claim 12, wherein when the processor cannot acquire the connection information of the device, the processor provides information that the connection information has not been acquired.

18. The management device according to claim 13, wherein when the processor cannot acquire the connection information of the device, the processor provides information that the connection information has not been acquired.

19. The management device according to claim 14, wherein when the processor cannot acquire the connection information of the device, the processor provides information that the connection information has not been acquired.
